(19) United States
(12) Patent Application Publication
(10) Pub. No.: US 2025/0237139 A1
(43) Pub. Date: Jul. 24, 2025

(54) SENSOR CORRELATION AND IDENTIFICATION FOR EVENT DETECTION

(71) Applicant: LYTT LIMITED, Middlesex (GB)

(72) Inventors: Cagri CERRAHOGLU, London (GB); Alessandro DELFINO, London (GB)

(73) Assignee: LYTT LIMITED, Middlesex (GB)

(21) Appl. No.: 18/853,048

(22) PCT Filed: Apr. 4, 2022
(86) PCT No.: PCT/EP2022/058876

§ 371 Date: Sep. 30, 2024

(51) Int. Cl. E21B 47/12; E21B 47/07; E21B 47/095; E21B 47/107; E21B 47/117; G01H 17/00; G08B 21/18

(52) U.S. Cl. CPC E21B 47/12; E21B 47/07; E21B 47/095; E21B 47/107; E21B 47/117; G01H 17/00; G08B 21/18

(57) ABSTRACT

A method of identifying parameters associated with an event comprises identifying an event at a first location, correlating the event with one or more sensor outputs, identifying at least one sensor output of the one or more sensor outputs correlated with the event at the first location; and displaying the at least one sensor output along with an indication of the event. The one or more sensor outputs are obtained from a location other than the first location.

### CROSS-REFERENCE TO RELATED APPLICATIONS

This application is a 35 U.S.C. § 371 national stage application of PCT/EP2022/058876 filed Apr. 4, 2022 and entitled “Sensor Correlation and Identification for Event Detection,” which is hereby incorporated herein by reference in its entirety for all purposes.

### STATEMENT REGARDING FEDERALLY SPONSORED RESEARCH OR DEVELOPMENT

Not applicable.

### BACKGROUND

It can be desirable to identify various events in a variety of settings. For example, events can be identified at a location or premises, along various pathways, or events associated with equipment of devices. Identifying events often requires information for a known instance of the event, which may not always be available, and even when available, may not match information for the event in different settings.

### BRIEF SUMMARY

In some embodiments, a method of identifying parameters associated with an event comprises identifying an event at a first location, correlating the event with one or more sensor outputs, identifying at least one sensor output of the one or more sensor outputs correlated with the event at the first location, and displaying the at least one sensor output along with an indication of the event. The one or more sensor outputs are obtained from a location other than the first location.

In some embodiments, a system of identifying parameters associated with an event comprises a processor and a memory storing a processing application. The processing application, when executed on the processor, configures the processor to: receive a signal originating at a first location, identify an event at the first location using the signal, correlate the event with one or more sensor outputs, identify at least one sensor output of the one or more sensor outputs correlated with the event at the first location, and display the at least one sensor output along with an indication of the event. The one or more sensor outputs originate from a location other than the first location.

In some embodiments, a method comprises: identify a first occurrence of an event at a first depth within a wellbore, correlating the event with one or more sensor outputs, identifying at least one sensor output of the one or more sensor outputs correlated with the event at the first depth, labeling training data using the at least one sensor output and the identification of the event from the first occurrence of the event, training a model using the training data, and identifying a second occurrence of the event using data for the at least one sensor output at a second time. The one or more sensor outputs are obtained from a location other than the first depth.

In some embodiments, a method of identifying fluid inflow within a sewer system comprises: identifying a fluid flow at a first location, correlating the fluid flow with one or more sensor outputs, identifying at least one sensor output of the one or more sensor outputs correlated with the fluid flow at the first location, and identifying a leak location in the sewer based on identifying the fluid flow and the at least one sensor output. The one or more sensor outputs are obtained from a plurality of locations along a sewer system.

The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a flow diagram of a method of identifying parameters associated with an event according to some embodiments;

FIG. 2 is a flow diagram of a method of controlling a system according to some embodiments;

FIG. 3 is a schematic, cross-sectional illustration of a downhole wellbore environment according to some embodiments;

FIG. 4A and FIG. 4B are schematic, cross-sectional views of embodiments of a well with a wellbore tubular having an optical fiber inserted therein according to some embodiments;

FIG. 5 is a schematic illustration of a security perimeter that can be integrity monitored according to some embodiments; and

FIG. 6 schematically illustrates a computer that may be used to carry out various methods according to some embodiments.

### DETAILED DESCRIPTION

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

Within various systems, an event within the system can result in other events, and/or an event within the system can have a cause in common with other events. It can often be difficult to identify an event or a cause of the event in distributed systems where an action at one location can cause an effect at a second (or potentially multiple second), and often remote, location(s). Depending on the availability of sensor data, locating the source or cause of an event and the various resultant effects throughout the system can be further complicated. Having a system for being able to correlate sensor readings at a location remote from the cause of an event can be useful in providing for an ability to identify, locate, and affect the conditions within the system leading to the event.

Disclosed herein are systems and methods for identifying an event and remote effects of the event so that the various information can be correlated and related within the system. Within various systems, an action or event at one location can have remote consequences or effects. For example, opening a valve in a pipeline can cause increased fluid flow. The opening of the valve itself can have various inputs and actions associated with the opening of the valve. For example, the opening of the valve can be measured by various positions sensors or the resulting sounds can be used to identify the fluid moving through the valve. After the valve is opened, various actions can occur downstream such as an increased flowrate or pressure. The downstream actions can be felt as various locations along the pipeline, each with a unique time delay as the fluid moves through the pipeline. The downstream changes can be associated with a time lag between the opening of the valve and the downstream actions. While there may be a time lag, the two events (e.g., opening the valve and a subsequent flowrate increase downstream) are linked to a common cause (e.g., movement of the valve). While in this example the cause is known, the same principle can be applied to other systems so long as both events are detectable, even if there is no known link between the two events. This then allows for various systems and models to be developed to allow for the identification and determination of an originating event in various systems.

In some aspects, the present systems and methods allow for a first event to be identified at a first location, using for example, a first sensor. One or more additional sensor outputs can then be used to identify an event, which can be the same or at least correlated with the first event, at one or more second locations, which are locations other than the first location. At least one of the one of more additional sensor outputs can then be displayed along with the identification of the first event. The correlation of the one or more additional sensor outputs can then be said to be correlated with the event, even though the one or more additional sensor outputs did not produce a sensor signal at the location of the event. This can then allow for a correlation or model to be developed in order to: 1) identify the event at the first location using the one or more additional sensor outputs, 2) identify a source of an event detected by at the second location, and/or 3) provide control parameters for the event at the first location using the one or more additional sensor outputs. Each of these is described in more detail herein.

In some aspects, the present systems and methods can allow for one or more point or location specific sensors to be correlated with distributed sensors such that an event at the first location can be correlated with one or more events and locations associated with the distributed sensor. For example, the distributed sensor can measure a parameter across an area, a pathway, or a length (e.g., a pathway that may or may not be linear), and multiple measurements may be taken across the pathway. Only some of the readings along the pathway may be correlated with the one or more point sensors, and the correlation or model can be used to identify the signal of interest at one or more sensor readings along the pathway that correlates with the event.

For example, various fluid flow systems can be associated with a fluid source. The fluid source can be monitored by various sensors such as a point sensor. Further distributed sensors along the flow path may measure the same or a different parameter, and the systems and methods described herein can be used to correlate a fluid flow from the fluid source with the sensor readings and/or features derived from the sensors readings along the fluid flow path as detected by a distributed sensor. In the example above, a flow meter associated with a flow valve in a pipeline can be used to measure an increased flowrate. A distributed acoustic sensor along the pipeline can then be used to identify an increase in flow based on an acoustic signal at one or more locations. This may allow for the increased flowrate to be used to label a dataset obtained from the acoustic sensor(s) to train a model to identify the flowrate. In this way, the event (e.g., an increased fluid flowrate through the pipeline) can be identified and used to label a data set from a distributed sensor to allow the acoustic sensor to later identify the increased flowrate as well as the cause being the opening of a valve.

The present systems and methods apply to various systems, which can each comprise one or more pieces of equipment, structures, or the like. Within each system, the individual components can be placed or assembled at different locations, which can be distributed in any suitable fashion. For example, various systems can comprise an industrial process, a pipeline, a security perimeter, a sewer pipe, a canal, wellbore, a flue or air duct, or can refer to a part of a system or a structure, such as a motor of the pump, or a portion/length of a pipeline, a security perimeter, or a structure such as a dam, bridge, section of roadway, building, tower, the like.

As used herein, the term acoustic signal(s) refers to signals representative of measurements of acoustic sounds, dynamic strain, vibrations, accelerations, and the like, whether or not within the audible or auditory range.

As utilized herein, a “fluid flow” within a wellbore context can include fluid inflow (e.g., any fluid inflow regardless of composition thereof), gas phase inflow, aqueous phase inflow, hydrocarbon phase inflow, any fluid outflow (e.g., any fluid outflow regardless of composition thereof), gas phase outflow, aqueous phase outflow, hydrocarbon phase outflow, fluid flow within the wellbore (e.g., any fluid flow regardless of the composition thereof), any fluid injection, any fluid phase flow or mixed phase flow, and/or any fluid flow through one or more leak paths or annuli within the wellbore. The fluid can comprise other components such as solid particulate matter (e.g., sand, etc.) in some embodiments, as discussed in more detail herein.

Disclosed herein are systems and methods for identifying events, for example, so that an operator may more effectively control an operation. As used herein, an “event” can include any occurrence or activity that produces a response that can be measured by a sensor. In some aspects, the response may be a physical response such as producing a sound, a change in temperature, pressure, or flowrate, or other suitable physical responses. In some aspects, other responses such as chemical, electrical, or structural responses may also occur that can be measured by a sensor. As an example, a fluid inflow into a wellbore can produce an acoustic response at the inflow location along with an associated change in temperature, pressure, and flowrate at the location of the inflow. Similarly, detecting rain may occur through the detection of the physical response of rain interacting with a sensor such as an acoustic sensor, flow rate sensor, conductivity sensor, or the like. Accordingly, a discussion of an event or a signal resulting from an event may, in some instances, refer to the resulting response associated with the event such that the “event” can be detected using the measured response.

According to embodiments of this disclosure, an event associated with an operation can be identified at a first location, and data corresponding to the event can be obtained at a different, second location and used to correlate the event occurrence and the data obtained at the second location. The data on the occurrence of the event at the first location can be identified in a number of ways including inducing or having a known, local event, and/or using one or more sensors at the first location to provide information to identify the event. For example, detecting a valve opening or fluid inflow into a wellbore can be detected using an acoustic, thermal, and/or strain sensor, or other sensors such as position sensors, flow sensors, pressure sensors, or the like. Data from sensors within a security perimeter or within an equipment or monitoring system, respectively, during the event can then be used to correlate with sensor data obtained from a second location. As used herein, the second location can comprise one or more locations, which can in some aspects, be monitored by a distributed sensors system. In some aspects, a distributed sensor system can be formed using a plurality of point sensors or one or more continuous sensors such as a fiber optic sensor that can be used to identify discrete locations (or a span of locations) as measurement locations. The second location can be remote from the first location, and the sensor data at the second location can detect an effect of the event. For example, a valve opening can create a change in pressure or flowrate at the second location, and the change in pressure or flowrate can be detecting using various sensors such as pressure and flowrate sensors. Once correlated, the sensor data from the second location can be associated with the event occurring at the first location, which can help to identify an origination location, a root cause, and/or information on how to control the parameters at the second location. In some aspects, the correlated data can be used to form training data for one or more models that might not otherwise be available, and/or provide data to allow one or more existing event identification models to be calibrated.

By way of example, in some embodiments, the first set of measurements can comprise temperature features that can be determined from temperature measurements taken along a length being monitored, such as a length of a periphery or perimeter, a length along a pipeline, or a length associated with one or more pieces of equipment (e.g., a pump, turbine, separator, valve, etc.). The temperature measurements can be used in one or more first event models that can provide an output indicative of an event at a first location, for example, security events along a perimeter. This can allow those locations with the event (e.g., security perimeter breach) to be identified using temperature-based measurements (e.g., from the location). Additional sensors can then monitor conditions at other locations. The resulting signals can then be correlated through location and/or time to identify a corresponding signal in the additional sensors. When a correlation exists, the additional sensor output can be used to identify the effect of the event and/or be associated with the event to help to identify the occurrence of the event from the additional sensor outputs.

While the systems and methods disclosed herein can apply across a variety of systems, an example using a wellbore context can be useful. During the completion of a wellbore, various types of equipment may be installed as part of the completion assembly. During production, certain events or operating conditions may cause various integrity events to occur. For example, sand can enter the wellbore from the formation at one or more production locations, which can be referred to as sand ingress. A distributed acoustic sensing system can be used to detect an acoustic signal associated with the sand ingress into the wellbore, and various processing systems can be used with the acoustic signal to identify the signal as comprising a sand ingress signature, thereby indicating the location of the sand ingress. Once the sand enters the wellbore, it can travel with the produced fluids to the surface of the wellbore where the sand can be detected using various types of sensors such as point sand sensors, sand being present in separators, sand passing through various logging tools, etc. The time for the sand to reach the surface may be delayed relative to the actual sand ingress by the time it takes the sand to travel to the surface, which can be on the order of hours. As a result, the correlation of the surface sensor data to the event detection data can be taken through time and location to try to align the sensor data. In order to improve the processing efficiency, a time window of the surface sensor data can be aligned with the expected arrival of the sand at the surface to limit the amount of data being processed as part of the correlation. Once the data is correlated, the origination of the event can be identified as the sand ingress location.

As a second example outside of the wellbore context, a sewage system can be monitored using various sensor systems, where the sewage system can be formed from a network of underground pipes. In some instances, leaks within the sewage system may allow a source of water, such as rainwater, to enter into the sewage system and increase the flowrate of the sewage within the sewage pipes. In order to understand the difference between an increase sewage flowrate due to increased usage and an increase due to leaks within the system, a separate sensor system such as a rain sensor using any suitable rain detection device can be used to initially identify the presence and potentially the amount of rain. A distributed sensor system within the sewage pipes such as a distributed temperature sensor and/or distributed acoustic sensor can be used to monitor the fluid flow within the pipes, which is remote from and can measure different sensor outputs from the rain sensor. Upon detection and identification of rain, the changes in the distributed sensor system within the sewage system can be monitored and correlate with the rain sensor. The correlation can serve to identify both those locations within the distributed sensing system that correlate with the rain event as well as identifying the time lag and relative amplitude of the signals correlated with the rain event. For example, data from the distributed monitoring system can be labelled with the rain event to help train or tune a model to identify the increased fluid flow within the sewage system. In this way, the leak locations can be identified and/or the increased flow rates can be used to help control the overall flow and flow velocity within the sewage system to help avoid overloading any sewage handling systems.

Although described primarily hereinbelow with reference to a wellbore environment, and a piece of equipment therein, the systems and methods of this disclosure are equally applicable for correlating events with remote sensor signals for pieces of equipment and/or systems in a non-wellbore environment; such non-wellbore applications are thus to be understood as included in this disclosure.

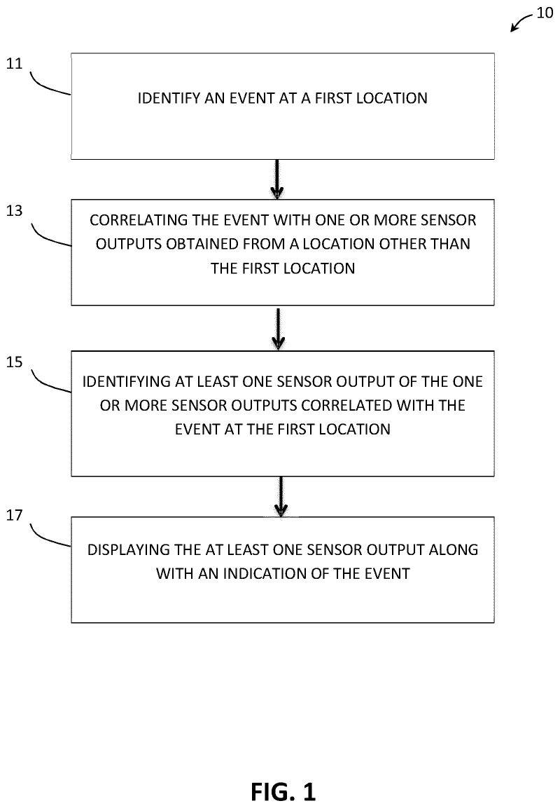

Herein disclosed is a method of correlating sensor outputs to identify events within a system. With reference to FIG. 1, which is a flow diagram of a method 10 of identifying parameters associated with an event according to some embodiments, the method according to aspects of this disclosure can comprise: identify an event at a first location 11; correlating the event with one or more sensor outputs obtained from a location other than the first location 13; identifying at least one sensor output of the one or more sensor outputs correlated with the event at the first location 15; and displaying the at least one sensor output along with an indication of the event 17.

As will become apparent to those of skill in the art upon reading this disclosure, the system and method of identifying parameters associated with an event as disclosed herein can be applicable to a variety of systems. In aspects, the system can be associated with (e.g., disposed within, adjacent to, and/or above) a wellbore and/or be the entire wellbore system. A variety of pieces of wellbore equipment can be envisioned as forming part of the system. The wellbore can comprise, for example, tools associated with an upper completions or tools and completion assemblies associated with a lower completions. For example, and without limitation, in embodiments, the system can comprise a tubing joint, a casing shoe, a production sleeve, a downhole pump, a gas lift mandrel (GLM), a production logging tool, a flow control device, a zonal isolation device, a valve, such as, without limitation, a zonal flow control valve, a well barrier (e.g., a cement barrier or portion thereof, a shoe, a casing shoe, etc.), a pump (e.g., an electric submersible pump (ESP)), or the like, or part thereof, associated with or within a wellbore. In some aspect, the system can comprise components associated with a wellbore but not in the wellbore such as various surface equipment, processing equipment, and the like. Sensors associated with any of these components can be associated with the systems as well.

In other embodiments, the components of the system may not be associated with or within a wellbore. Such equipment can be associated with a variety of systems, such as, without limitation, monitoring of pipelines, sewage systems, security perimeters, power and utilities plants and conduits (e.g., wind energy), subsea cables, infrastructures, dams, mines, railways, highways, smart cities, production plants, (e.g., refineries), or the like. For example, and without limitation, such non-wellbore systems can include, without limitation, a pipeline, a pump, a rail, a roadway, a security perimeter, a building, a dam, a mine tunnel, a sewage pipe, a production plant, a windmill, a cable, a pump, a valve, a road, a motor, a portion thereof, a combination thereof, or another such piece of equipment.

The identification of the event at the first location at step 11 can rely on the detection of a signal at or near the first location. The signal can comprise an acoustic signal, a thermal signal, a strain signal, a pressure signal, a temperature signal, a flow signal, a current, a voltage, or any other suitable sensor signal including combinations thereof. For example, in embodiments, the signal comprises a thermal signal, and the event can be identified using one or more samples within the thermal signal and/or one or more features derived from the thermal signal. The use of various features of an acoustic signal, a thermal signal, and/or a strain signal are discussed in more detail herein. When features of the signal(s) are used, the identification of the event at the first location can comprise determining one or more features from the signal, using the one or more features of the signal as an input into one or more event and/or anomaly detection models, and determining the presence and identity of the event at the first location using the outputs of the one or more event and/or anomaly detection models. In some aspects, one or more properties of the event can be identified using the signal, including any features thereof.

In some embodiments, the signal comprises an acoustic signal. In such embodiments, identifying the event at the first location can comprise obtaining an acoustic signal at the first location, determining a plurality of frequency domain features from the acoustic signal, using at least one frequency domain feature of the plurality of frequency domain features as an input to an event model, and determining the presence and identity of the event at the first location using an output of the event model. Methods of obtaining the frequency domain features from an acoustic signal are described in more detail herein.

In some embodiments, the signal comprises a thermal signal. In such embodiments, identifying the event at the first location can comprise obtaining a thermal signal at the first location, determining a plurality of temperature features from the thermal signal, using at least one temperature feature of the plurality of temperature features as an input to an event model, and determining the presence and identity of the event at the first location using an output of the event model. Methods of obtaining the temperatures features from a thermal signal are described in more detail herein.

In some embodiments, the signal comprises a strain signal. In such embodiments, identifying the event at the first location can comprise obtaining a strain signal at the first location, determining a plurality of strain features from the thermal signal, using at least one strain feature of the plurality of strain features as an input to an event model, and determining the presence and identity of the event at the first location using an output of the event model. Methods of obtaining the strain features from a strain signal are described in more detail herein.

When other sensors are used, the event may be identified using a model and/or the output directly from the sensor. For example, a pressure sensor may provide a pressure that can be used with a model or correlation to identify an event, while a rain sensor may be used to directly indicate the presence of rain. Other types of sensors can be equally used to identify events or properties of events.

Once the event is identified at step 11, the event can be correlated with one or more sensor outputs, where the sensor outputs can be obtained from a second location that is separated in location from the first location. For example, the one or more sensors can be located at the surface of a wellbore whereas the event can be detected within a wellbore. Similarly, the one or more sensors may be located in a pipeline at a location that is remote from a valve that is actuated to increase or decrease flow. Similarly, various flow and/or temperature sensors can be disposed within a sewage system where the conduits are remote from a surface rain sensor. Similarly, an acoustic sensor may be located apart from a thermal sensor in a security system, where a sound of an event (e.g., a vehicle entering a perimeter) may travel to the remove acoustic sensor to be identify or detect the event at the first location. For example, the one or more sensors at the second location can also include acoustic, thermal, strain, pressure, flow, or similar sensors.

Alternatively, the one or more sensors may not be acoustic, thermal, or strain sensors such that the one or more sensors at the second location are different than those used to identify the event, and/or the one or more sensor output signals are different than those used to identify the event at the first location. While any suitable sensor can be used at the second location, the one or more sensors can comprise a temperature sensor, a flow meter, a pressure sensor, a choke position sensor, a valve position sensor, or a pump setting sensor, a controller output, a rain sensor, or the like.

In some aspects, correlating the event with the one or more sensor outputs can generally comprise identify a signal or signal signature in the one or more sensor outputs (or in features derived from the one or more sensor outputs) that corresponds to the signals used to identify the event. Using sand ingress example, the ingress of sand into a wellbore can produce an acoustic signal representative of sand entering and impinging on the wellbore. When an acoustic signal is used to identify the sand ingress, various frequency domain features and/or acoustic amplitudes can be used to identify and detect the ingress of sand. Similarly, when the sand reaches the surface, various sensors used to detect sand in the produced fluids may also see an increased output that represents the increased presence of sand in the produced fluid. While the signals may be offset in time, and the exact characteristics of the resulting output signals may not be identical, the increased presence of sand ingress can be correlated with an increased sand concentration in the produced fluids.

The resulting correlation can provide an identified link between the event within the system at the first location and the sensor outputs detected at a second location. This can be used to identify an event using the one or more sensor outputs, identify a source of the event, identify a location of the event, and/or identify various control variables for controlling the event.

In some aspects, the correlating of the event with the one or more sensor outputs can allow for the identification of the event using the one or more sensor outputs. The correlation can identify a relationship between the one or more sensor outputs and the event as well as a time lag or delay between the occurrence of the event and the detection of the corresponding signals at the one or more sensors. This information can be used to create training data for one or more models that can use the data and/or features derived from the one or more sensors as inputs and provide an identification of the event as an output. The output can comprise a binary output (e.g., a present/not present) or a likelihood of the occurrence of the event. Other outputs providing an indication of an event are also possible. In this sense the correlation can be seen as providing labelled data used for training of various machine learning models to identify an event using data obtained at a location other than the event location. In some embodiments, the various event models can comprise a multivariate model, a machine learning model using supervised or unsupervised learning algorithms, or the like.

The correlation can also be used to identify a location of the event. Once the event is correlated with the one or more sensor outputs, the event can be validated or verified based on the correlation. For example, when a potential event or anomaly is identified within a wellbore or pipeline, the correlation may provide confirmation of the event. The event can then be verified at the location of the potential event or anomaly. As an example, the detection of an increased flowrate within a pipeline can be correlated with an attempt to open a valve. The increased flowrate would then verify that the valve opened, even though a flow meter measuring the rate is not present at the location of the valve.

Within the method 10, the various steps can be performed in any order. In some aspects, an event can be correlated with the one or more sensor outputs before the event is identified at the first location. Using the wellbore example, the data from one or more surface sensors may indicate an increased presence of sand in the produced fluids. The one or more sensors can be correlated with various signals within the wellbore. Any anomaly or likely indication of sand ingress can then be identified as the source of the sand ingress. The event can then be identified at the first location even though the one or more sensor outputs originated the correlation of the data. The resulting correlation can then be used identify the event and its location.

The correlating can also be used to identify a root cause of an event. When the correlating identifies a link between the one or ore sensor outputs and the event at the first location, the resulting link in the causation can then be used to identify which portions of a system are affected by the event occurring within the system. In some aspects, this can include identifying one or more portions of a distributed sensing system that are correlated with the event, for example by identifying the one or more portions that correlate with the outputs of the first sensor. This information can then be used upon the next occurrence of the event to identify which portions of the system will be affected, the degree to which they are affected, and the time lag until they are affected within the system.

As described herein, various events can be correlated using the method 10. When the system is associated with a wellbore, the events can include, but are not limited to, sand ingress, fluid inflow, fluid flow along the wellbore, a leak event, an overburden event, a fracture, or any combination thereof. In some aspects, the events may not be associated with a wellbore. For example, the event(s) can comprise a security event, a transportation event, a geothermal event, a facility monitoring event, a pipeline monitoring event, a dam monitoring event, or any combination thereof.

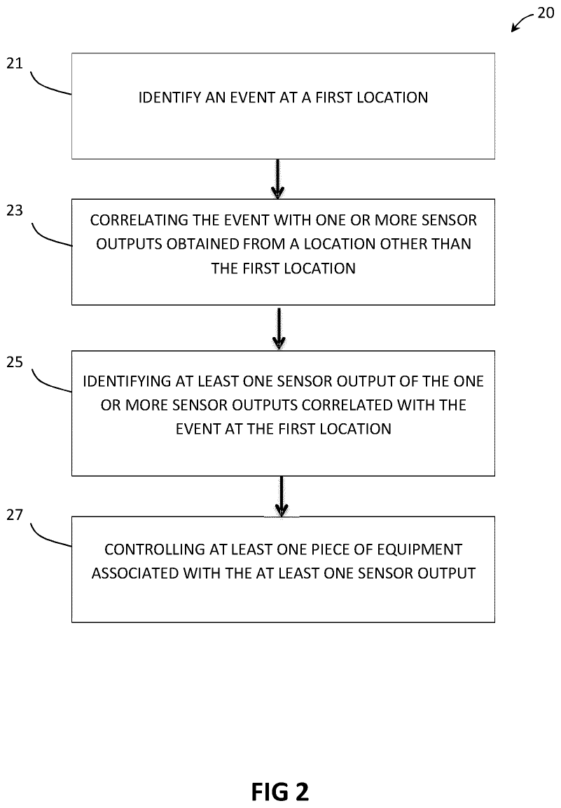

In some aspects, the correlating can be used to control the system and/or affect an event within the system. As depicted in FIG. 2, which is a flow diagram of a method of controlling a system 20 according to some embodiments, the method can comprise identify an event at a first location within the system 21, correlating the event with one or more sensor outputs obtained from a location other than the first location 23, identifying at least one sensor output of the one or more sensor outputs correlated with the event at the first location 25, controlling at least one piece of equipment associated with the at least one sensor output 27, and optionally, changing the event based on controlling the at least one piece of equipment.

The method 20 can generally be the same or similar to the method 10, and like elements are not re-described in the interest of brevity. The main difference between the methods is the control of the piece of equipment associated with the one or more sensor outputs correlated with the event. When the one or more sensors are correlated with the event, the equipment or portion of the system associated with the one or more sensors can be controlled by identifying and controlling one or more inputs or variables associated with the event at the first location. In some aspects, the equipment or portion of the system associated with the one or more sensors can be controlled to adjust for the event prior to the occurrence of the event. When either the portion of the system at the first location and/or the portion of the system associated with the one or more sensors is controlled, the event or its effects on the system can be optionally changed. For example, the ability to identify an event and the resulting downstream effects of that event can allow the portion of the system associated with the one or more sensors to be controlled to avoid the effects of the event at the second location.

The methods as described above an be applied to a wellbore context in some aspects. In these aspects, the method can comprise identify a first occurrence of an event at a first depth within a wellbore, correlating the event with one or more sensor outputs obtained from a location other than the first depth, identifying at least one sensor output of the one or more sensor outputs correlated with the event at the first depth, labelling training data using the at least one sensor output and the identification of the event from the first occurrence of the event, training a model using the training data, and identifying a second occurrence of the event using data for the at least one sensor output at a second time. The identification of the occurrence of the event can be performed using any of the steps as described herein.

The labelled training data provided by this method can be used to train various types of supervised and/or unsupervised models. In some embodiments, the various models can comprise a multivariate model, a machine learning model using supervised or unsupervised learning algorithms, or the like. Once developed and trained, the model can be used with the one or more sensor outputs at the second location to provide an identification of the occurrence of the event at a later time.

As described above, the signal can comprise an acoustic signal, a thermal signal, a strain signal, or any combination thereof. The one or more features can comprise at least one frequency domain feature of the acoustic signal, as described further hereinbelow. The signal can be pre-processed prior to determining the one or more features. For example, in embodiments, the signal can be preprocessed to remove background noise. In some aspects, the signal comprises an acoustic signal, and determining the one or more features comprises filtering the acoustic signal within a first frequency range; and determining the one or more features within the first frequency range.

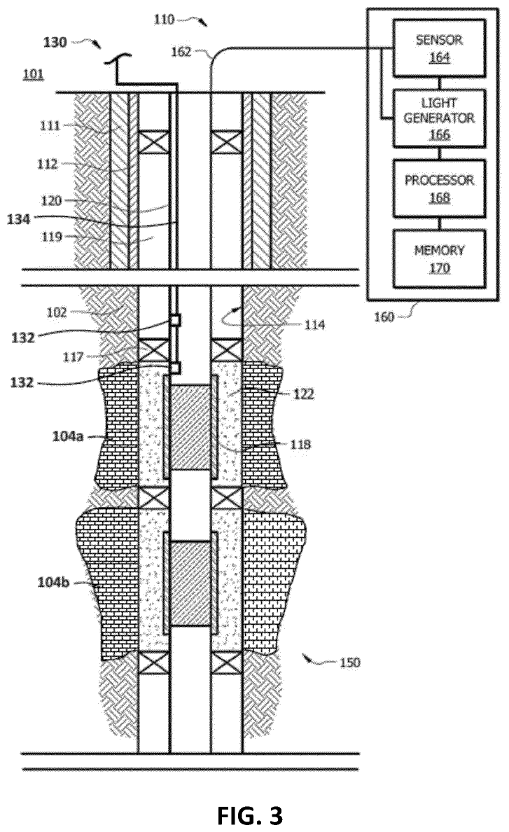

Various sensors can be utilized to obtain the signal, a number of which are discussed hereinbelow. In embodiments, the sensor can comprise an acoustic sensor disposed at the location of the piece of equipment. For example, in aspects, the sensor can comprise a distributed fiber optic cable running along a length of the wellbore 114 as described herein with reference to FIG. 3.

In some instances, the systems and methods can provide information in real time or near real time. As used herein, the term “real time” refers to a time that takes into account various communication and latency delays within a system, and can include actions taken within about ten seconds, within about thirty seconds, within about a minute, within about five minutes, or within about ten minutes of the action occurring. Various sensors (e.g., distributed temperature sensing sensors, distributed fiber optic acoustic sensors, point temperature sensors, point acoustic sensors, production logging tools, etc.) can be used to obtain a distributed temperature signal and/or an acoustic signal at various points along a length being monitored, for example, along a wellbore. The distributed temperature sensing signal and/or the acoustic signal can then be processed using signal processing architecture with various feature extraction techniques (e.g., temperature feature extraction techniques, spectral feature extraction techniques) to obtain a measure of one or more temperature features, one or more frequency domain features, one or more strain features, and/or combinations thereof that enable selectively extracting the distributed temperature sensing signals, strain, and/or acoustic signals of interest from background noise and consequently aiding in improving the accuracy of the identification and prediction of events, including, for example, the movement of fluids (e.g., gas inflow locations, water inflow locations, hydrocarbon liquid inflow locations, etc.) in real time, and the predicting of integrity events. While discussed in terms of being real time in some instances, the data can also be analyzed at a later time at the same location and/or a displaced location. For example, the data can be logged and later analyzed at the same or a different location.

As used herein, various frequency domain features can be obtained from the acoustic signal, and in some contexts, the frequency domain features can also be referred to herein as spectral features or spectral descriptors. In some embodiments, the spectral features can comprise other features, including those in the time domain, various transforms (e.g., wavelets, Fourier transforms, etc.), and/or those derived from portions of the acoustic signal or other sensor inputs. Such other features can be used on their own or in combination with one or more frequency domain features, including in the development of transformations of the features, as described in more detail herein.

In some embodiments, distributed temperature sensing signals and acoustic signal(s) can be obtained in a manner that allows for a signal to be obtained along a length of the sensor, for example, an entire wellbore or a portion of interest (e.g., a depth) thereof. In wellbore contexts, production logging systems can use a production logging system (PLS) to determine flow profile in wells. The PLS can be 10-20 meters long and the sensors can be distributed along the length of the PLS. The PLS can measure a variety of parameters such as temperatures, pressures, flow rates, phase measurements (e.g., gas flow rate, water flow rate, hydrocarbon flow rate, etc.), and the like. Furthermore, a PLS can be run through a well once or a few times (down and then up once or a few times and out), and the sensors may be exposed to the conditions at a given depth for a defined period of time (e.g., seconds to hours). Accordingly, PLSs can provide an indication that certain events, such as downhole water inflow, may be occurring, on a time scale sufficient to identify an event to allow additional measurements to be obtained and used for predicting.

Fiber optic distributed temperature sensors (DTS) and fiber optic distributed acoustic sensors (DAS) can capture distributed temperature sensing and acoustic signals, respectively, resulting from downhole events, such as wellbore events (e.g., gas flow, hydrocarbon liquid flow, water flow, mixed flow, leaks, overburden movement, and the like), as well as other background events. This allows for signal processing procedures that distinguish events and flow signals from other sources to properly identify each type of event. This in turn results in a need for a clearer understanding of the fingerprint of in-well event of interest (e.g., an equipment integrity event) in order to be able to segregate and identify a signal resulting from an event of interest from other ambient background signals. As used herein, the resulting fingerprint of a particular event can also be referred to as an event signature, as described in more detail herein. In some embodiments, temperature features and acoustic features can each be used with a model (e.g., a machine learning model such as a multivariate model, neural network, etc.) as described with respect to the methods herein to provide for detection, identification, and/or determination of the extents of various events. A number of different models can be developed and used to determine when and where certain events have occurred within a wellbore and/or the extents of such events.

Once obtained, the features can be used in various models in order to be able to segregate a noise resulting from an event of interest from other ambient background noise. Specific models can be determined for each event by considering one or more temperature features, acoustic features, and/or strain (e.g., dynamic strain, static strain, etc.) features for known integrity events. The combination of the features with an identification of the event and/or parameters associated with the event can be used to form a known data set used for training, which can be referred to as a labeled data set. From these known events, features specific to each event can be developed and signatures (e.g., having ranges or thresholds) and/or models can be established to determine a presence (or absence) of each event, and a prediction therefor. Based on the specifics of each feature, the resulting signatures or models can be used to sufficiently distinguish between events to allow for a relatively fast identification and prediction of such events. The resulting signatures or models can then be used along with processed signal data to determine if an event occurs at a point of interest along the path of the sensor(s).

Any of the processing techniques disclosed herein can be used to initially determine a signature or model(s), and then process and compare the relevant features in a sampled signal with the resulting signatures or model(s). According to this disclosure, the events within the system can be identified based on one or more event models. Features associated with identified events can then be used to train an event model using sensor data obtained from the one or more sensors at the second location that can be physically disparate from the data utilized to identify the event via the one or more event identification models. The trained event model(s) using the one or more sensor signals at the second location can then be utilized to more accurately identify various events within the system.

One or more models can be developed using event data from the first location and the one or more sensors to provide a labeled data set used as input for training the event model using the one or more sensor signals. The resulting trained models can then be used to identify one or more signatures based on features of the one or more sensor data and one or more machine learning techniques to develop correlations for the identification of various events. In the model development, the features of the model (e.g. one or more outputs of the one or more sensors, etc.) can be obtained and recorded from further events to further develop the event identification model via a feedback loop. The model can be trained to identify one or more events associated with one or more pieces of equipment in the system. The resulting event identification model can then be used to identify one or more events associated with the same portion of the system (e.g., the same or similar piece of equipment).

In some embodiments, the temperature, strain, and/or acoustic measurements can be used with one or more temperature, acoustic, and/or acoustic signatures, respectively, to predict an integrity event associated with the at least one piece of equipment. The signatures can comprise a number of thresholds or ranges for comparison with various features. When the detected features fall within the signatures, the integrity event may be predicted.

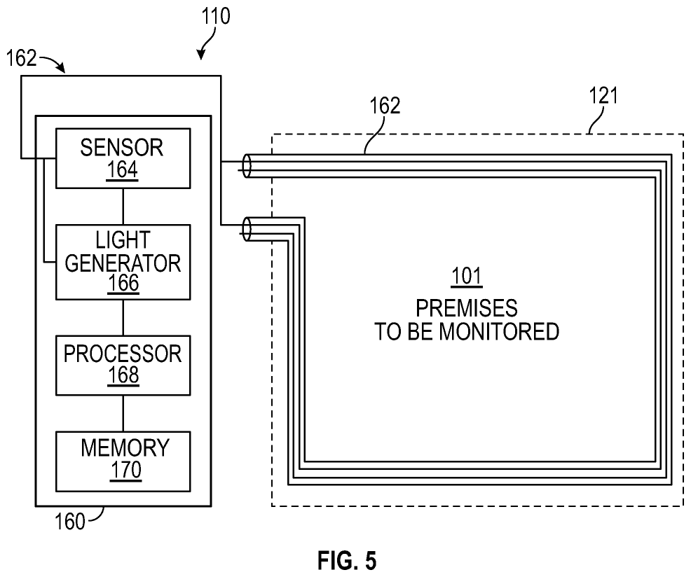

In some aspects, the at least one piece of equipment can be in a wellbore environment, such as environment 101 of FIG. 3, or a non-wellbore environment, such as non-wellbore environment 101 of FIG. 5. A wellbore environment will now be described with reference to a FIG. 3, which is a schematic, cross-sectional illustration of a downhole wellbore operating environment 101 according to some embodiments. More specifically, environment 101 includes a wellbore 114 traversing a subterranean formation 102, casing 112 lining at least a portion of wellbore 114, and a tubular 120 extending through wellbore 114 and casing 112. A plurality of completion assemblies such as spaced screen elements or assemblies 118 may be provided along tubular 120 at one or more production zones 104a, 104b within the subterranean formation 102. In particular, two production zones 104a, 104b are depicted within subterranean formation 102 of FIG. 3; however, the precise number and spacing of the production zones 104a, 104b may be varied in different embodiments. The completion assemblies can comprise flow control devices such as sliding sleeves, adjustable chokes, and/or inflow control devices to allow for control of the flow from each production zone. The production zones 104a, 104b may be layers, zones, or strata of formation 102 that contain hydrocarbon fluids (e.g., oil, gas, condensate, etc.) therein.

In addition, a plurality of spaced zonal isolation devices 117 and gravel packs 122 may be provided between tubular 120 and the sidewall of wellbore 114 at or along the interface of the wellbore 114 with the production zones 104a, 104b. In some embodiments, the operating environment 101 includes a workover and/or drilling rig positioned at the surface and extending over the wellbore 114. While FIG. 3 shows an example completion configuration in FIG. 3, it should be appreciated that other configurations and equipment may be present in place of or in addition to the illustrated configurations and equipment. For example, sections of the wellbore 114 can be completed as open hole completions or with gravel packs without completion assemblies.

In general, the wellbore 114 can be formed in the subterranean formation 102 using any suitable technique (e.g., drilling). The wellbore 114 can extend substantially vertically from the earth's surface over a vertical wellbore portion, deviate from vertical relative to the earth's surface over a deviated wellbore portion, and/or transition to a horizontal wellbore portion. In general, all or portions of a wellbore may be vertical, deviated at any suitable angle, horizontal, and/or curved. In addition, the wellbore 114 can be a new wellbore, an existing wellbore, a straight wellbore, an extended reach wellbore, a sidetracked wellbore, a multi-lateral wellbore, and other types of wellbores for drilling and completing one or more production zones. As illustrated, the wellbore 114 includes a substantially vertical producing section 150 which includes the production zones 104a, 104b. In this embodiment, producing section 150 is an open-hole completion (i.e., casing 112 does not extend through producing section 150). Although section 150 is illustrated as a vertical and open-hole portion of wellbore 114 in FIG. 3, embodiments disclosed herein can be employed in sections of wellbores having any orientation, and in open or cased sections of wellbores. The casing 112 extends into the wellbore 114 from the surface and can be secured within the wellbore 114 with cement 111.

The tubular 120 may comprise any suitable downhole tubular or tubular string (e.g., drill string, casing, liner, jointed tubing, and/or coiled tubing, etc.), and may be inserted within wellbore 114 for any suitable operation(s) (e.g., drilling, completion, intervention, workover, treatment, production, etc.). In the embodiment shown in FIG. 3, the tubular 120 is a completion assembly string. In addition, the tubular 120 may be disposed within in any or all portions of the wellbore 114 (e.g., vertical, deviated, horizontal, and/or curved section of wellbore 114).

In this embodiment, the tubular 120 extends from the surface to the production zones 104a, 104b and generally provides a conduit for fluids to travel from the formation 102 (particularly from production zones 104a, 104b) to the surface. A completion assembly including the tubular 120 can include a variety of other equipment or downhole tools to facilitate the production of the formation fluids from the production zones. For example, zonal isolation devices 117 can be used to isolate the production zones 104a, 104b within the wellbore 114. In this embodiment, each zonal isolation device 117 comprises a packer (e.g., production packer, gravel pack packer, frac-pac packer, etc.). The zonal isolation devices 117 can be positioned between the screen assemblies 118, for example, to isolate different gravel pack zones or intervals along the wellbore 114 from each other. In general, the space between each pair of adjacent zonal isolation devices 117 defines a production interval, and each production interval may correspond with one of the production zones 104a, 104b of subterranean formation 102.

The screen assemblies 118 provide sand control capability. In particular, the sand control screen elements 118, or other filter media associated with wellbore tubular 120, can be designed to allow fluids to flow therethrough but restrict and/or prevent particulate matter of sufficient size from flowing therethrough. The screen assemblies 118 can be of any suitable type such as the type known as “wire-wrapped”, which are made up of a wire closely wrapped helically about a wellbore tubular, with a spacing between the wire wraps being chosen to allow fluid flow through the filter media while keeping particulates that are greater than a selected size from passing between the wire wraps. Other types of filter media can also be provided along the tubular 120 and can include any type of structures commonly used in gravel pack well completions, which permit the flow of fluids through the filter or screen while restricting and/or blocking the flow of particulates (e.g. other commercially-available screens, slotted or perforated liners or pipes; sintered-metal screens; sintered-sized, mesh screens; screened pipes; prepacked screens and/or liners; or combinations thereof). A protective outer shroud having a plurality of perforations therethrough may be positioned around the exterior of any such filter medium.

The gravel packs 122 can be formed in the annulus 119 between the screen elements 118 (or tubular 120) and the sidewall of the wellbore 114 in an open hole completion. In general, the gravel packs 122 comprise relatively coarse granular material placed in the annulus to form a rough screen against the ingress of sand into the wellbore while also supporting the wellbore wall. The gravel pack 122 is optional and may not be present in all completions.

In some embodiments, one or more of the completion assemblies can comprise flow control elements such as sliding sleeves, chokes, valves, or other types of flow control devices that can control the flow of a fluid from an individual production zone or a group of production zones. The force on the production face can then vary based on the type of completion within the wellbore and/or each production zone (e.g., in a sliding sleeve completion, open hole completion, gravel pack completion, etc.). In some embodiments, a sliding sleeve or other flow controlled production zone can experience a force on the production face that is relatively uniform within the production zone, and the force on the production face can be different between each production zone. For example, a first production zone can have a specific flow control setting that allows the production rate from the first zone to be different than the production rate from a second production zone. Thus, the choice of completion type (e.g., which can be specified in a completion plan) can effect on the need for or the ability to provide a different production rate within different production zones.

Referring still to FIG. 3, a monitoring system 110 can comprise an acoustic monitoring system, a temperature monitoring system, and/or a strain monitoring system. The monitoring system 110 can be positioned in the wellbore 114. As described herein, the monitoring system 110 may be utilized to detect or monitor various event(s) in and/or around the wellbore 114. The various monitoring systems (e.g., acoustic monitoring systems, temperature monitoring systems, strain monitoring systems, etc.) may be referred to herein as an event monitoring systems 110.

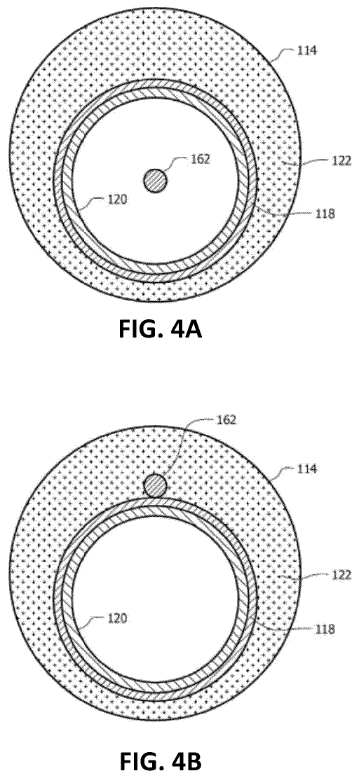

The monitoring system 110 comprises an optical fiber 162 that is coupled to and extends along tubular 120. In cased completions, the optical fiber 162 can be installed between the casing and the wellbore wall within a cement layer and/or installed within the casing or production tubing. Referring briefly to FIGS. 4A and 4B, optical fiber 162 of the monitoring system 110 may be coupled to an exterior of tubular 120 (e.g., such as shown in FIG. 4B) or an interior of tubular (e.g., such as shown in FIG. 4A). When the optical fiber 162 is coupled to the exterior of the tubular 120, as depicted in the embodiment of FIG. 48, the optical fiber 162 can be positioned within a control line, control channel, or recess in the tubular 120. In some embodiments an outer shroud contains the tubular 120 and protects the optical fiber 162 during installation. A control line or channel can be formed in the shroud and the optical fiber 162 can be placed in the control line or channel (not specifically shown in FIGS. 4A and 4B).

As noted hereinabove, the at least one piece of equipment can be in a non-wellbore environment. Such a non-wellbore environment will now be described with reference to FIG. 5, which is a schematic illustration of an operating environment or “premises” 101 (e.g. a security perimeter environment 101) that can be integrity monitored according to some embodiments. More specifically, environment 101 includes a perimeter or periphery traversed by optical fiber 162 along length 121. Although described as a periphery or perimeter, any length 121 along a premises 101 can be monitored, for example, a length of train track or road for transportation monitoring applications, a length around a building for security monitoring applications, a length of fiber optical cable disposed in contact with one or more pieces of equipment, etc. That is, the monitored length need not be a periphery in the usual sense, as it need not (but can, in some aspects) surround or encircle any specific area of the premises.

Referring still to FIG. 3 and FIG. 5, a monitoring system 110 can comprise an acoustic monitoring system, a temperature monitoring system, and/or a strain monitoring system. The monitoring system 110 can be positioned on or proximate the premises 101. As described herein, the monitoring system 110 may be utilized to detect or monitor event(s) on the premises 101. The various monitoring systems (e.g., acoustic monitoring systems, temperature monitoring systems, strain monitoring systems, etc.) may be referred to herein as a “detection system,” and/or a “monitoring system.”

In some aspects, the monitoring system 110 can comprise an optical fiber 162 that extends along length 121 (e.g., the periphery) of wellbore 114 or perimeter of environment 101. For example, the optical fiber 162 can be buried along a periphery of an area, disposed within a pipeline, placed within a sewage pipeline, coupled to a railway and/or placed under a railway or roadway (e.g., during construction or in a pipeline installed afterwards), suspended or floated in water, or any other type of installation that can acoustically, thermally, or otherwise couple the optical fiber 162 to the system being monitored.

Generally speaking, during operation of the monitoring system, an optical backscatter component of light injected into the optical fiber 162 may be used to detect various conditions incident on the optical fiber such as acoustic perturbations (e.g., dynamic strain), temperature, static strain, and the like along the length of the optical fiber 162. The light can be generated by a light generator or source 166 such as a laser, which can generate light pulses. The light used in the system is not limited to the visible spectrum, and light of any frequency can be used with the systems described herein. Accordingly, the optical fiber 162 acts as the sensor element with no additional transducers in the optical path, and measurements can be taken along the length of the entire optical fiber 162. The measurements can then be detected by an optical receiver such as sensor 164 and selectively filtered to obtain measurements from a given depth point or range, thereby providing for a distributed measurement that has selective data for a plurality of zones (e.g., production zones 104a, 104b) along the optical fiber 162 at any given time. For example, time of flight measurements of the backscattered light can be used to identify individual zones or measurement lengths of the fiber optic 162. In this manner, the optical fiber 162 effectively functions as a distributed array of sensors spread over the entire length of the optical fiber 162, for example across production zones 104a, 104b within the wellbore 114 or about perimeter 121.

The light backscattered up the optical fiber 162 as a result of the optical backscatter can travel back to the source, where the signal can be collected by a sensor 164 and processed (e.g., using a processor 168). In general, the time the light takes to return to the collection point is proportional to the distance traveled along the optical fiber 162, thereby allowing time of flight measurements of distance along the optical fiber. The resulting backscattered light arising along the length of the optical fiber 162 can be used to characterize the environment around the optical fiber 162. The use of a controlled light source 166 (e.g., having a controlled spectral width and frequency) may allow the backscatter to be collected and any parameters and/or disturbances along the length of the optical fiber 162 to be analyzed. In general, the various parameters and/or disturbances along the length of the optical fiber 162 can result in a change in the properties of the backscattered light.

An acquisition device 160 may be coupled to one end of the optical fiber 162 that comprises the sensor 164, light generator 166, a processor 168, and a memory 170. As discussed herein, the light source 166 can generate the light (e.g., one or more light pulses), and the sensor 164 can collect and analyze the backscattered light returning along the optical fiber 162. In some contexts, the acquisition device 160 (which comprises the light source 166 and the sensor 164 as noted above), can be referred to as an interrogator. The processor 168 may be in signal communication with the sensor 164 and may perform various analysis steps described in more detail herein. While shown as being within the acquisition device 160, the processor 168 can also be located outside of the acquisition device 160 including being located remotely from the acquisition device 160. The sensor 164 can be used to obtain data at various rates and may obtain data at a sufficient rate to detect the acoustic signals of interest with sufficient bandwidth. While described as a sensor 164 in a singular sense, the sensor 164 can comprise one or more photodetectors or other sensors that can allow one or more light beams and/or backscattered light to be detected for further processing. In an embodiment, depth resolution ranges in a range of from about 1 meter to about 10 meters, or less than or equal to about 10, 9, 8, 7, 6, 5, 4, 3, 2, or 1 meter can be achieved. Depending on the resolution needed, larger averages or ranges can be used for computing purposes. When a high depth resolution is not needed, a system may have a wider resolution (e.g., which may be less expensive) can also be used in some embodiments. Data acquired by the monitoring system 110 (e.g., via fiber 162, sensor 164, etc.) may be stored on memory 170.

The monitoring system 110 can be used for detecting a variety of parameters and/or disturbances in the environment 101, including being used to detect temperatures, acoustic signals, static strain, and/or pressure, or any combination thereof.

In some embodiments, the monitoring system 110 can be used to detect temperatures within the environment 101 (e.g., within wellbore 114). The temperature monitoring system can include a distributed temperature sensing (DTS) system. A DTS system can rely on light injected into the optical fiber 162 along with the reflected signals to determine a temperature and/or strain based on optical time-domain reflectometry. In order to obtain DTS measurements, a pulsed laser from the light generator 166 can be coupled to the optical fiber 162 that serves as the sensing element. The injected light can be backscattered as the pulse propagates through the optical fiber 162 owing to density and composition as well as to molecular and bulk vibrations. A portion of the backscattered light can be guided back to the acquisition device 160 and split of by a directional coupler to a sensor 164. It is expected that the intensity of the backscattered light decays exponentially with time. As the speed of light within the optical fiber 162 is known, the distance that the light has passed through the optical fiber 162 can be derived using time of flight measurements.

In both distributed acoustic sensing (DAS) and DTS systems, as well as strain sensing systems, the backscattered light includes different spectral components which contain peaks that are known as Rayleigh and Brillouin peaks and Raman bands. The Rayleigh peaks are independent of temperature and can be used to determine the DAS components of the backscattered light. The Raman spectral bands are caused by thermally influenced molecular vibrations. The Raman spectral bands can then be used to obtain information about distribution of temperature along the length of the optical fiber 162 disposed in the wellbore.

The Raman backscattered light has two components, Stokes and Anti-Stokes, one being only weakly dependent on temperature and the other being greatly influenced by temperature. The relative intensities between the Stokes and Anti-Stokes components and are a function of temperature at which the backscattering occurred. Therefore, temperature can be determined at any point along the length of the optical fiber 162 by comparing at each point the Stokes and Anti-stokes components of the light backscattered from the particular point. The Brillouin peaks may be used to monitor strain along the length of the optical fiber 162.

The DTS system can then be used to provide a temperature measurement along the length of the optical fiber (e.g., during the production of fluids, including fluid inflow events in wellbore 114). The DTS system can represent a separate system from the DAS system or a single common system, which can comprise one or more acquisition devices in some embodiments. In some embodiments, a plurality of fibers 162 are present within the environment 101, and the DAS system can be coupled to a first optical fiber and the DTS system can be coupled to a second, different, optical fiber. Alternatively, a single optical fiber can be used with both systems, and a time division multiplexing or other process can be used to measure both DAS and DTS on the same optical fiber.

In an embodiment, depth resolution for the DAS, DTS, and/or strain monitoring system can range from about 1 meter to about 10 meters, or less than or equal to about 10, 9, 8, 7, 6, 5, 4, 3, 2, or 1 meter can be achieved. Depending on the resolution needed, larger averages or ranges can be used for computing purposes. When a high depth resolution is not needed, a system may have a wider resolution (e.g., which may be less expensive) can also be used in some embodiments. Data acquired by the DTS system 110 (e.g., via fiber 162, sensor 164, etc.) may be stored on memory 170.

While the temperature monitoring system described herein can use a DTS system to acquire the temperature measurements for a location or length/depth range in the environment 101, in general, any suitable temperature monitoring system can be used. For example, various point sensors, thermocouples, resistive temperature sensors, or other sensors can be used to provide temperature measurements at a given location based on the temperature measurement processing described herein. Further, an optical fiber comprising a plurality of point sensors such as Bragg gratings can also be used. As described herein, a benefit of the use of the DTS system is that temperature measurements can be obtained across a plurality of locations and/or across a continuous length rather than at discrete locations.

The monitoring system 110 can comprise an acoustic monitoring system to monitor acoustic signals within the environment 101. The acoustic monitoring system can comprise a DAS based system, though other types of acoustic monitoring systems, including other distributed monitoring systems, can also be used.

During operation of a DAS system an optical backscatter component of light injected into the optical fiber 162 (e.g., Rayleigh backscatter) may be used to detect acoustic perturbations (e.g., dynamic strain) along the length of the fiber 162. The light backscattered back to the optical fiber 162 as a result of the optical backscatter can travel back to the source, where the signal can be collected by a sensor 164 and processed (e.g., using a processor 168) as described herein. In general, any acoustic or dynamic strain disturbances along the length of the optical fiber 162 can result in a change in the properties of the backscattered light, allowing for a distributed measurement of both the acoustic magnitude (e.g., amplitude), frequency and, in some cases, of the relative phase of the disturbance. Any suitable detection methods including the use of highly coherent light beams, compensating interferometers, local oscillators, and the like can be used to produce one or more signals that can be processed to determine the acoustic signals or strain impacting the optical fiber along its length.

While the system 101 described herein can be used with a DAS system (e.g., DAS system 110) to acquire an acoustic signal for a location or depth/length range in the environment 101 (e.g., wellbore 114), in general, any suitable acoustic signal acquisition system can be used in performing embodiments of method 10 (see e.g., FIG. 1). For example, various microphones, geophones, hydrophones, or other sensors can be used to provide an acoustic signal at a given location based on the acoustic signal processing described herein. Further, an optical fiber comprising a plurality of point sensors such as Bragg gratings can also be used. As described herein, a benefit of the use of the DAS system 110 is that an acoustic signal can be obtained across a plurality of locations and/or across a continuous length of the environment 101, rather than at discrete locations.

The monitoring system 110 can be used to generate temperature measurements, strain measurements, and/or acoustic measurements along the length of the optical fiber 162. The resulting measurements can be processed to obtain various temperature, strain, and/or acoustic based features that can then be used to identify one or more events, including any of those described herein. Each of the specific types of features obtained from the monitoring system is described in more detail below.

The temperature features, strain features, and/or frequency domain features can be understood by considering an example of fluid inflow into the wellbore. In this example, fluid can be produced into the wellbore 114 and into the completion assembly string. During operations, the fluid flowing into the wellbore may comprise hydrocarbon fluids, such as, for instance hydrocarbon liquids (e.g., oil), gases (e.g., natural gas such as methane, ethane, etc.), and/or water, any of which can also comprise particulates such as sand. However, the fluid flowing into the tubular may also comprise other components, such as, for instance steam, carbon dioxide, and/or various multiphase mixed flows. The fluid flow can further be time varying such as including slugging, bubbling, or time altering flow rates of different phases. The amounts or flow rates of these components can vary over time based on conditions within the formation 102 and the wellbore 114. Likewise, the composition of the fluid flowing into the tubular 120 sections throughout the length of the entire production string (e.g., including the amount of sand contained within the fluid flow) can vary significantly from section to section at any given time.

Continuing with the example, as the fluid enters the wellbore 114, the fluid can create acoustic signals and temperature changes that can be detected by the monitoring system such as the DTS system and/or the DAS systems as described herein. With respect to the temperature variations, the temperature changes can result from various fluid effects within the wellbore such as cooling based on gas entering the wellbore, temperature changes resulting from liquids entering the wellbore, and various flow related temperature changes as a result of the fluids passing through the wellbore. For example, as fluids enter the wellbore, the fluids can experience a sudden pressure drop, which can result in a change in the temperature. The magnitude of the temperature change depends on the phase and composition of the inflowing fluid, the pressure drop, and the pressure and temperature conditions. The other major thermodynamic process that takes place as the fluid enters the well is thermal mixing which results from the heat exchange between the fluid body that flows into the wellbore and the fluid that is already flowing in the wellbore. As a result, inflow of fluids from the reservoir into the wellbore can cause a deviation in the flowing well temperature profile. Other events within the wellbore can also generate similar temperature, strain, and/or acoustic signals that can be used to identify and/or predict an equipment condition.

By obtaining the temperature in the environment 101 (e.g., wellbore 114), a number of temperature features can be obtained from the temperature measurements. The temperature features can provide an indication of one or more temperature trends at a given location (e.g., at a location of the piece of equipment) during a measurement period. The resulting features can form a distribution of temperature results that can then be used with various models to identify an integrity event associated with a piece of equipment within the environment 101 at the location.

The temperature measurements can represent output values from the DTS system, which can be used with or without various types of pre-processing such as noise reduction, smoothing, and the like. When background temperature measurements are used, the background measurement can represent a temperature measurement at a location within the environment 101 (e.g., at the at least one piece of equipment) taken in the absence of the flow of a fluid. For example, a temperature profile along the wellbore can be taken when the well is initially formed and/or the wellbore can be shut in and allowed to equilibrate to some degree before measuring the temperatures at various points in the wellbore. The resulting background temperature measurements or temperature profile can then be used in determining the temperature features in some embodiments.

In general, the temperature features represent statistical variations of the temperature measurements through time and/or depth. For example, the temperature features can represent statistical measurements or functions of the temperature within the wellbore that can be used with various models to determine whether or not fluid flow events have occurred. The temperature features can be determined using various functions and transformations, and in some embodiments can represent a distribution of results. In some embodiments, the temperature features can represent a normal or Gaussian distribution. In some embodiments, the temperature measurements can represent measurement through time and length/depth, such as variations taken first with respect to time and then with respect to depth/length or first with respect to depth/length and then with respect to time. The resulting distributions can then be used with models such as multivariate models to determine the presence of the fluid flow events.

In some embodiments, the temperature features can include various features including, but not limited to, a depth derivative of temperature with respect to depth, a temperature excursion measurement, a baseline temperature excursion, a peak-to-peak value, a Fast Fourier transform (FFT), a Laplace transform, a wavelet transform, a derivative of temperature with respect to depth, a heat loss parameter, an autocorrelation, and combinations thereof.

In some embodiments, the temperature features can comprise a depth derivative of temperature with respect to depth. This feature can be determined by taking the temperature measurements along the wellbore and smoothing the measurements. Smoothing can comprise a variety of steps including filtering the results, de-noising the results, or the like. In some embodiments, the temperature measurements can be median filtered within a given window to smooth the measurements. Once smoothed, the change in the temperature with depth can be determined. In some embodiments, this can include taking a derivative of the temperature measurements with respect to depth along the longitudinal axis of the wellbore 114. The depth derivative of temperature values can then be processed, and the measurement with a zero value (e.g., representing a point of no change in temperature with depth) that have preceding and proceeding values that are non-zero and have opposite signs in depth (e.g., zero below which the value is negative and above positive or vice versa) can have the values assign to the nearest value. This can then result in a set of measurements representing the depth derivative of temperature with respect to depth.

In some embodiments, the temperature features can comprise a temperature excursion measurement. The temperature excursion measurement can comprise a difference between a temperature reading at a first depth and a smoothed temperature reading over a depth range, where the first depth is within the depth range. In some embodiments, the temperature excursion measurement can represent a difference between de-trended temperature measurements over an interval and the actual temperature measurements within the interval. For example, a depth range can be selected within the wellbore 114. The temperature readings within a time window can be obtained within the depth range and de-trended or smoothed. In some embodiments, the de-trending or smoothing can include any of those processes described above, such as using median filtering of the data within a window within the depth range. For median filtering, the larger the window of values used, the greater the smoothing effect can be on the measurements. For the temperature excursion measurement, a range of windows from about 10 to about 100 values, or between about 20-60 values (e.g., measurements of temperature within the depth range) can be used to median filter the temperature measurements. A difference can then be taken between the temperature measurement at a location and the de-trended (e.g., median filtered) temperature values. The temperature measurements at a location can be within the depth range and the values being used for the median filtering. This temperature feature then represents a temperature excursion at a location along the wellbore 114 from a smoothed temperature measurement over a larger range of depths around the location in the wellbore 114.

In some embodiments, the temperature features can comprise a baseline temperature excursion. The baseline temperature excursion represents a difference between a de-trended baseline temperature profile and the current temperature at a given depth. In some embodiments, the baseline temperature excursion can rely on a baseline temperature profile that can contain or define the baseline temperatures along the length of the wellbore 114. As described herein, the baseline temperatures represent the temperature as measured when the wellbore 114 is shut in. This can represent a temperature profile of the formation in the absence of fluid flow. While the wellbore 114 may affect the baseline temperature readings, the baseline temperature profile can approximate a formation temperature profile. The baseline temperature profile can be determined when the wellbore 114 is shut in and/or during formation of the wellbore 114, and the resulting baseline temperature profile can be used over time. If the condition of the wellbore 114 changes over time, the wellbore 114 can be shut in and a new baseline temperature profile can be measured or determined. It is not expected that the baseline temperature profile is re-determined at specific intervals, and rather it would be determined at discrete times in the life of the wellbore 114. In some embodiments, the baseline temperature profile can be re-determined and used to determine one or more temperature features such as the baseline temperature excursion.

Once the baseline temperature profile is obtained, the baseline temperature measurements at a location in the wellbore 114 can be subtracted from the temperature measurement detected by the temperature monitoring system 110 at that location to provide baseline subtracted values. The results can then be obtained and smoothed or de-trended. For example, the resulting baseline subtracted values can be median filtered within a window to smooth the data. In some embodiments, a window between 10 and 500 temperature values, between 50 and 400 temperature values, or between 100 and 300 temperature values can be used to median filter the resulting baseline subtracted values. The resulting smoothed baseline subtracted values can then be processed to determine a change in the smoothed baseline subtracted values with depth. In some embodiments, this can include taking a derivative of the smoothed baseline subtracted values with respect to depth along the longitudinal axis of the wellbore. The resulting values can represent the baseline temperature excursion feature.

In some embodiments, the temperature features can comprise a peak-to-peak temperature value. This feature can represent the difference between the maximum and minimum values (e.g., the range, etc.) within the temperature profile along the wellbore 114. In some embodiments, the peak-to-peak temperature values can be determined by detecting the maximum temperature readings (e.g., the peaks) and the minimum temperature values (e.g., the dips) within the temperature profile along the wellbore 114. The difference can then be determined within the temperature profile to determine peak-to-peak values along the length of the wellbore 114. The resulting peak-to-peak values can then be processed to determine a change in the peak-to-peak values with respect to depth. In some embodiments, this can include taking a derivative of the peak-to-peak values with respect to depth along the longitudinal axis of the wellbore 114. The resulting values can represent the peak-to-peak temperature values.

Other temperature features can also be determined from the temperature measurements. In some embodiments, various statistical measurements can be obtained from the temperature measurements along the wellbore 114 to determine one or more temperature features. For example, a cross-correlation of the temperature measurements with respect to time can be used to determine a cross-correlated temperature feature. The temperature measurements can be smoothed as described herein prior to determining the cross-correlation with respect to time. As another example, an autocorrelation measurement of the temperature measurements can be obtained with respect to depth. Autocorrelation is defined as the cross-correlation of a signal with itself. An autocorrelation temperature feature can thus measure the similarity of the signal with itself as a function of the displacement. An autocorrelation temperature feature can be used, in applications, as a means of anomaly detection for one or more events (e.g., fluid flow, fluid leaks, sand ingress, etc.). The temperature measurements can be smoothed and/or the resulting autocorrelation measurements can be smoothed as described herein to determine the autocorrelation temperature features.

In some embodiments, the temperature features can comprise a Fast Fourier transform (FFT) of the distributed temperature sensing (e.g., DTS) signal. This algorithm can transform the distributed temperature sensing signal from the time domain into the frequency domain, thus allowing detection of the deviation in DTS along length (e.g., depth). This temperature feature can be utilized, for example, for anomaly detection for one or more events.

In some embodiments, the temperature features can comprise the Laplace transform of DTS. This algorithm can transform the DTS signal from the time domain into Laplace domain allows us to detect the deviation in the DTS along length (e.g., depth of wellbore 114). This temperature feature can be utilized, for example, for anomaly detection for event detection. This feature can be utilized, for example, in addition to (e.g., in combination with) the FFT temperature feature.

In some embodiments, the temperature features can comprise a wavelet transform of the distributed temperature sensing (e.g., DTS) signal and/or of the derivative of DTS with respect to depth, dT/dz. The wavelet transform can be used to represent the abrupt changes in the signal data. This feature can be utilized, for example, in fluid flow detection. A wavelet is described as an oscillation that has zero mean, which can thus make the derivative of DTS in depth more suitable for this application. In embodiments and without limitation, the wavelet can comprise a Morse wavelet, an Analytical wavelet, a Bump wavelet, or a combination thereof.

In some embodiments, the temperature features can comprise a derivative of DTS with respect to depth, or dT/dz. The relationship between the derivative of flowing temperature T_{f} with respect to depth (L) (e.g., dT_{f}/dL) has been described by several models. For example, and without limitation, the model described by Sagar (Sagar, R., Doty, D. R., & Schmidt, Z. (1991, November 1). Predicting Temperature Profiles in a Flowing Well. Society of Petroleum Engineers. doi:10.2118/19702-PA) which accounts for radial heat loss due to conduction and describes a relationship (Equation (1) below) between temperature change in depth and mass rate. The mass rate wₜ is conversely proportional to the relaxation parameter A and, as the relaxation parameter A increases, the change in temperature in depth increases. Hence this temperature feature can be designed to be used, for example, in events comprising flow quantification.

$$\frac{δ {T}_{f}}{d L} = - A [ ( {T}_{f} - {T}_{e} ) + \frac{g}{{g}_{c}} + \frac{sin θ}{{JC}_{pm} A} - \frac{{F}_{c}}{A} ] . \qquad ( 1 )$$

The formula for the relaxation parameter, A, is provided in Equation (2):

$$A = ( \frac{2 π}{{w}_{t} {C}_{pl}} ) ( \frac{{r}_{ti} {Uk}_{e}}{{k}_{e} + {r}_{ti} Uf / 12} ) ( \frac{1}{86 , 400 \times 12} ) \qquad ( 2 )$$

A=coefficient, ft⁻¹
C_{pL}=specific heat of liquid, Btu/lbm-° F.
Cₚₘ=specific heat of mixture, Btu/lbm-° F.
Cₚₒ=specific heat of oil, Btu/lbm-° F.
C_{pw}=specific heat of water, Btu/lbm-° F.
d_{c}=casing diameter, in.
dₜ=tubing diameter, in.
d_{wb}=wellbore diameter, in.
D=depth, ft
Dᵢₙⱼ=injection depth, ft
ƒ=modified dimensionless heat conduction time function for long times for earth
ƒ(t)=dimensionless transient beat conduction time function for earth
F_{c}=correction factor
F̅_̅{̅c̅}̅=average correction factor for one length interval
g=acceleration of gravity, 32.2 ft/sec²
g_{c}=conversion factor, 32.2 ft-lbm/sec²-lbf
g_{G}=geothermal gradient, ° F./ft
h=specific enthalpy, Btu/lbm
J=mechanical equivalent of heat, 778 ft-lbf/Btu
kₐₙ=thermal conductivity of material in annulus, Btu/D-ft-° F.
k_{ang}=thermal conductivity of gas in annulus, Btu/D-ft-° F.
k_{anw}=thermal conductivity of water in annulus, Btu/D-ft-° F.
k_{cem}=thermal conductivity of cement, Btu/D-ft-° F.
kₑ=thermal conductivity of earth, Btu/D-ft-° F.
L=length of well from perforations, ft
Lᵢₙ=length from perforation to inlet, ft
p=pressure, psi
p_{wh}=wellhead pressure, psig
q_{gf}=formation gas flow rate, scf/D
q_{ginj}=injection gas flow rate, scf/D
qₒ=oil flow rate, STB/D
q_{w}=water flow rate, STB/D
Q=heat transfer between fluid and surrounding area, Btu/lbm
r_{ci}=inside casing radius, in,
r_{co}=outside casing radius, in.
rₜᵢ=inside tubing radius, in.
rₜₒ=outside tubing radius, in.
r_{wh}=wellbore radius, in.
R_{gL}=gas/liquid ratio, scf/STB
T=temperature, ° F.
T_{bh}=bottomhole temperature, ° F.
T_{c}=casing temperature, ° F.
Tₑ=surrounding earth temperature, ° F.
Tₑᵢₙ=earth temperature at inlet, ° F.
T_{f}=flowing fluid temperature, ° F.
T_{fin}=flowing fluid temperature at inlet, ° F.
Tₕ=cement/earth interface temperature, ° F.
U=overall heat transfer coefficient, Btu/D-ft²-° F.
v=fluid velocity, ft/sec
V=volume
wₜ=total mass flow rate, lbm/sec
Z=height from bottom of hole, ft
Zᵢₙ=height from bottom of hole at inlet, ft
α=thermal diffusivity of earth, 0.04 ft²/hr
γ_{API}=oil gravity, ° API
γ_{g}=gas specific gravity (air=1)
γₒ=oil specific gravity
γ_{w}=water specific gravity
θ=angle of inclination, degrees
μ=Joule-Thomson coefficient

In some embodiments, the temperature features can comprise a heat loss parameter. As described hereinabove, Sagar's model describes the relationship between various input parameters, including the mass rate wₜ and temperature change in depth dT_{f}/d_{L}. These parameters can be utilized as temperature features in a machine learning model which uses features from known cases (production logging results) as learning data sets, when available. These features can include geothermal temperature, deviation, dimensions of the tubulars 120 that are in the well (casing 112, tubing 120, gravel pack 122 components, etc.), as well as the wellbore 114, well head pressure, individual separator rates, downhole pressure, gas/liquid ratio, and/or a combination thereof. Such heat loss parameters can, for example, be utilized as inputs in a machine learning model for events comprising fluid flow quantification of the mass flow rate wₜ.

In some embodiments, the temperature features an comprise a time-depth derivative and/or a depth-time derivative (which can also be referred to as a time-length derivative and/or length-time derivative in non-wellbore contexts). A temperature feature comprising a time-depth derivative can comprise a change in a temperature measurement at one or more locations across the wellbore taken first with respect to time, and a change in the resulting values with respect to depth can then be determined. Similarly, a temperature feature comprising a depth-time derivative can comprise a change in a temperature measurement at one or more locations across the wellbore taken first with respect to depth, and a change in the resulting values with respect to time can then be determined.

In some embodiments, the temperature features can be based on dynamic temperature measurements rather than steady state or flowing temperature measurements. In order to obtain dynamic temperature measurements, a change in the operation of the system (e.g., wellbore) can be introduced, and the temperature monitored using the temperature monitoring system. For example in a wellbore environment, the change in conditions can be introduced by shutting in the wellbore, opening one or more sections of the wellbore to flow, introducing a fluid to the wellbore (e.g., injecting a fluid), and the like. When the wellbore is shut in from a flowing state, the temperature profile along the wellbore may be expected to change from the flowing profile to the baseline profile over time. Similarly, when a wellbore that is shut in is opened for flow, the temperature profile may change from a baseline profile to a flowing profile. Based on the change in the condition of the wellbore, the temperature measurements can change dynamically over time. In some embodiments, this approach can allow for a contrast in thermal conductivity to be determined between a location or interval having radial flow (e.g., into or out of the wellbore) to a location or interval without radial flow. One or more temperature features can then be determined using the dynamic temperature measurements. Once the temperature features are determined from the temperature measurements obtained from the temperature monitoring system, one or more of the temperature features can be used to identify events (e.g., fluid inflow) and predict integrity events (e.g., completions failure) along the length being monitored (e.g., within the wellbore), as described in more detail herein.

As described with respect to the temperature measurements, the flow of fluids in the wellbore 114 and pieces of equipment therein can also create acoustic sounds that can be detected using the acoustic monitoring system such as a DAS system. Accordingly, the flow of the various fluids in the wellbore 114 and/or through the wellbore 114 can create vibrations or acoustic sounds that can be detected using acoustic monitoring system. Each type of fluid flow event such as the different fluid flows and fluid flow locations can produce an acoustic signature with unique frequency domain features. Other events such as leaks, overburden movements, equipment failures, and the like (e.g., any of the events described herein) can also create acoustic signals that can have a unique relationship between one or more frequency domain features. Similar acoustic events may be present in non-wellbore contexts such as pipeline leaks, leaks into underground pipes, movement of vehicles, and the like.

As used herein, various frequency domain features can be obtained from the acoustic signal, and in some contexts, the frequency domain features can also be referred to herein as spectral features or spectral descriptors. The frequency domain features are features obtained from a frequency domain analysis of the acoustic signals obtained within the wellbore. The frequency domain features can be derived from the full spectrum of the frequency domain of the acoustic signal such that each of the frequency domain features can be representative of the frequency spectrum of the acoustic signal. Further, a plurality of different frequency domain features can be obtained from the same acoustic signal (e.g., the same acoustic signal at a location or depth within the wellbore), where each of the different frequency domain features is representative of frequencies across the same frequency spectrum of the acoustic signal as the other frequency domain features. For example, the frequency domain features (e.g., each frequency domain feature) can be a statistical shape measurement or spectral shape function of the spectral power measurement across the same frequency bandwidth of the acoustic signal. Further, as used herein, frequency domain features can also refer to features or feature sets derived from one or more frequency domain features, including combinations of features, mathematical modifications to the one or more frequency domain features, rates of change of the one or more frequency domain features, and the like.

In order to determine the frequency domain features, an acoustic signal can be obtained using the acoustic monitoring system during operation of the wellbore. The resulting acoustic signal can be optionally pre-processed using a number of steps. Depending on the type of DAS system employed, the optical data may or may not be phase coherent and may be pre-processed to improve the signal quality (e.g., denoised for opto-electronic noise normalization/de-trending single point-reflection noise removal through the use of median filtering techniques or even through the use of spatial moving average computations with averaging windows set to the spatial resolution of the acquisition unit, etc.). The raw optical data from the acoustic sensor can be received, processed, and generated by the sensor to produce the acoustic signal.

In some embodiments, a processor or collection of processors (e.g., processor 168 in FIG. 3) may be utilized to perform the optional pre-processing steps described herein. In an embodiment, the noise detrended “acoustic variant” data can be subjected to an optional spatial filtering step following the other pre-processing steps, if present. A spatial sample point filter can be applied that uses a filter to obtain a portion of the acoustic signal corresponding to a desired depth or depth range in the wellbore. Since the time the light pulse sent into the optical fiber returns as backscattered light can correspond to the travel distance, and therefore depth in the wellbore, the acoustic data can be processed to obtain a sample indicative of the desired depth or depth range. This may allow a specific location within the wellbore (e.g., at or near a location of the piece of equipment) to be isolated for further analysis. The pre-processing may also include removal of spurious back reflection type noises at specific depths through spatial median filtering or spatial averaging techniques. This is an optional step and helps focus primarily on an interval of interest in the wellbore. For example, the spatial filtering step can be used to focus on a producing interval where there is high likelihood of sand ingress, for example. The resulting data set produced through the conversion of the raw optical data can be referred to as the acoustic sample data.

The acoustic data, including the optionally pre-processed and/or filtered data, can be transformed from the time domain into the frequency domain using a transform. For example, a Fourier transform such as a Discrete Fourier transformations (DFT), a short time Fourier transform (STFT), or the like can be used to transform the acoustic data measured at each depth section along the fiber or a section thereof into a frequency domain representation of the signal. The resulting frequency domain representation of the data can then be used to provide the data from which the plurality of frequency domain features can be determined. Spectral feature extraction using the frequency domain features through time and space can be used to determine one or more frequency domain features.

The use of frequency domain features to identify fluid flow events and locations, flow phase identification, and/or flow quantities of one or more fluid phases can provide a number of advantages. First, the use of frequency domain features results in significant data reduction relative to the raw DAS data stream. Thus, a number of frequency domain features can be calculated and used to allow for event identification while the remaining data can be discarded or otherwise stored, and the remaining analysis can be performed using the frequency domain features. Even when the raw DAS data is stored, the remaining processing power is significantly reduced through the use of the frequency domain features rather than the raw acoustic data itself. Further, the use of the frequency domain features can, with the appropriate selection of one or more of the frequency domain features, provide a concise, quantitative measure of the spectral character or acoustic signature of specific sounds pertinent to downhole fluid surveillance and other applications.

While a number of frequency domain features can be determined for the acoustic sample data, not every frequency domain feature may be used to identify fluid flow events and locations, flow phase identification, and/or flow quantities of one or more fluid phases. The frequency domain features represent specific properties or characteristics of the acoustic signals.

In some embodiments, combinations of frequency domain features can be used as the frequency domain features themselves, and the resulting combinations are considered to be part of the frequency domain features as described herein. In some embodiments, a plurality of frequency domain features can be transformed to create values that can be used to define various event signatures. This can include mathematical transformations including ratios, equations, rates of change, transforms (e.g., wavelets, Fourier transforms, other wave form transforms, etc.), other features derived from the feature set, and/or the like as well as the use of various equations that can define lines, surfaces, volumes, or multi-variable envelopes. The transformation can use other measurements or values outside of the frequency domain features as part of the transformation. For example, time domain features, other acoustic features, and non-acoustic measurements can also be used. In this type of analysis, time can also be considered as a factor in addition to the frequency domain features themselves. As an example, a plurality of frequency domain features can be used to define a surface (e.g., a plane, a three-dimensional surface, etc.) in a multivariable space, and the measured frequency domain features can then be used to determine if the specific readings from an acoustic sample fall above or below the surface. The positioning of the readings relative to the surface can then be used to determine if the event is present or not at that location in that detected acoustic sample.

The frequency domain features can include any frequency domain features derived from the frequency domain representations of the acoustic data. Such frequency domain features can include, but are not limited to, the spectral centroid, the spectral spread, the spectral roll-off, the spectral skewness, the root mean square (RMS) band energy (or the normalized sub-band energies/band energy ratios), a loudness or total RMS energy, a spectral flatness, a spectral slope, a spectral kurtosis, a spectral flux, a spectral autocorrelation function, or a normalized variant thereof.

The spectral centroid denotes the “brightness” of the sound captured by the optical fiber (e.g., optical fiber 162 shown in FIG. 3) and indicates the center of gravity of the frequency spectrum in the acoustic sample. The spectral centroid can be calculated as the weighted mean of the frequencies present in the signal, where the magnitudes of the frequencies present can be used as their weights in some embodiments.

The spectral spread is a measure of the shape of the spectrum and helps measure how the spectrum is distributed around the spectral centroid. In order to compute the spectral spread, Si, one has to take the deviation of the spectrum from the computed centroid as per the following equation (all other terms defined above):

$${S}_{i} = \sqrt{\frac{{\sum }_{k = 1}^{N} {( f ( k ) - {C}_{i} )}^{2} {X}_{i} ( k )}{{\sum }_{k = 1}^{N} {X}_{i} ( k )}} . \qquad ( Eq . 2 )$$

The spectral roll-off is a measure of the bandwidth of the audio signal. The Spectral roll-off of the i^{th} frame, is defined as the frequency bin ‘y’ below which the accumulated magnitudes of the short-time Fourier transform reach a certain percentage value (usually between 85%-95%) of the overall sum of magnitudes of the spectrum.

$${\sum }_{k = 1}^{y} \vert {X}_{i} ( k ) \vert = \frac{c}{100} {\sum }_{k = 1}^{N} \vert {X}_{i} ( k ) \vert , \qquad ( Eq . 3 )$$

where c=85 or 95. The result of the spectral roll-off calculation is a bin index and enables distinguishing acoustic events based on dominant energy contributions in the frequency domain (e.g., between gas influx and liquid flow, etc.).

The spectral skewness measures the symmetry of the distribution of the spectral magnitude values around their arithmetic mean.

The RMS band energy provides a measure of the signal energy within defined frequency bins that may then be used for signal amplitude population. The selection of the bandwidths can be based on the characteristics of the captured acoustic signal. In some embodiments, a sub-band energy ratio representing the ratio of the upper frequency in the selected band to the lower frequency in the selected band can range between about 1.5:1 to about 3:1. In some embodiments, the sub-band energy ratio can range from about 2.5:1 to about 1.8:1, or alternatively be about 2:1 The total RMS energy of the acoustic waveform calculated in the time domain can indicate the loudness of the acoustic signal. In some embodiments, the total RMS energy can also be extracted from the temporal domain after filtering the signal for noise.

The spectral flatness is a measure of the noisiness/tonality of an acoustic spectrum. It can be computed by the ratio of the geometric mean to the arithmetic mean of the energy spectrum value and may be used as an alternative approach to detect broad-banded signals. For tonal signals, the spectral flatness can be close to 0 and for broader band signals it can be closer to 1.

The spectral slope provides a basic approximation of the spectrum shape by a linearly regressed line. The spectral slope represents the decrease of the spectral amplitudes from low to high frequencies (e.g., a spectral tilt). The slope, the y-intersection, and the max and media regression error may be used as features.

The spectral kurtosis provides a measure of the flatness of a distribution around the mean value.

The spectral flux is a measure of instantaneous changes in the magnitude of a spectrum. It provides a measure of the frame-to-frame squared difference of the spectral magnitude vector summed across all frequencies or a selected portion of the spectrum. Signals with slowly varying (or nearly constant) spectral properties (e.g., noise) have a low spectral flux, while signals with abrupt spectral changes have a high spectral flux. The spectral flux can allow for a direct measure of the local spectral rate of change and consequently serves as an event detection scheme that could be used to pick up the onset of acoustic events that may then be further analyzed using the feature set above to identify and uniquely classify the acoustic signal.

The spectral autocorrelation function provides a method in which the signal is shifted, and for each signal shift (lag) the correlation or the resemblance of the shifted signal with the original one is computed. This enables computation of the fundamental period by choosing the lag, for which the signal best resembles itself, for example, where the autocorrelation is maximized. This can be useful in exploratory signature analysis/even for anomaly detection for well integrity monitoring across specific depths where well barrier elements to be monitored are positioned.

Any of these frequency domain features, or any combination of these frequency domain features (including transformations of any of the frequency domain features and combinations thereof), can be used to detect and identify one or more events and locations. In some aspects, a selected set of characteristics can be used to identify the events, and/or all of the frequency domain features that are calculated can be used as a group in identifying and predicting the integrity events. The specific values for the frequency domain features that are calculated can vary depending on the specific attributes of the acoustic signal acquisition system, such that the absolute value of each frequency domain feature can change between systems. In some aspects, the frequency domain features can be calculated for each integrity event based on the system being used to capture the acoustic signal and/or the differences between systems can be taken into account in determining the frequency domain feature values for each fluid inflow event between or among the systems used to determine the values and the systems used to capture the acoustic signal being evaluated. For example, the frequency domain features can be normalized based on the acquired values to provide more consistent readings between systems and locations.

One or a plurality of frequency domain features can be used to identify and predict integrity events at the locations of the pieces of equipment. In an embodiment, one, or at least two, three, four, five, six, seven, eight, etc. different frequency domain features can be used to identify or to predict the integrity events at the equipment location(s). The frequency domain features can be combined or transformed in order to define the event signatures for one or more integrity events, such as, for instance, a packer failure. While exemplary numerical ranges are provided herein, the actual numerical results may vary depending on the data acquisition system and/or the values can be normalized or otherwise processed to provide different results.

In aspects, the features comprise one or more strain features. Such strain features can include features such as statistical features derived from a strain signal, which can be a dynamic strain signal and/or astatic strain signal. In some aspects, the features can be changes of the strain signal with respect to time and/or length along the sensor. For example, the strain features can include rate of change of static strain and/or dynamic strain, or autocorrelation and/or cross correlation thereof. In some aspects, the strain features can include a change of the strain, such as static strain, with length or length and time. Strain features can also include combinations, transformations, or other functions of strain in the time or frequency domain.

As part of the event detection at the first location, and/or as part of the processing of the one or more sensor outputs, the temperature features, frequency domain features, and strain features can be obtained during the processes and systems described herein. The temperature features can be determined using the temperature monitoring system to obtain temperature measurements at the location of the piece of equipment (e.g., along the length being monitored, such as along the length of the fiber optic cable 162). In some embodiments, a DTS system can be used to receive distributed temperature measurement signals from a sensor disposed along the length (e.g., the length of the wellbore), such as an optical fiber 162. The resulting signals from the temperature monitoring system can be used to determine one or more temperature features as described herein. In some embodiments, a baseline or background temperature profile can be used to determine the temperature features, and the baseline temperature profile can be obtained prior to obtaining the temperature measurements.

In some embodiments, a plurality of temperature features can be determined from the temperature measurements, and the plurality of temperature features can comprise at least two of: a depth derivative of temperature with respect to depth, a temperature excursion measurement, a baseline temperature excursion, a peak-to-peak value, a fast Fourier transform, a Laplace transform, a wavelet transform, a derivative of temperature with respect to length (e.g., depth), a heat loss parameter, an autocorrelation, as detailed hereinabove, and/or the like. Other temperature features can also be used in some embodiments. The temperature excursion measurement can comprise a difference between a temperature reading at a first depth, and a smoothed temperature reading over a depth range, where the first depth is within the depth range. The baseline temperature excursion can comprise a derivative of a baseline excursion with depth, where the baseline excursion can comprise a difference between a baseline temperature profile and a smoothed temperature profile. The peak-to-peak value can comprise a derivative of a peak-to-peak difference with depth, where the peak-to-peak difference comprises a difference between a peak high temperature reading and a peak low temperature reading with an interval. The fast Fourier Transform can comprise an FFT of the distributed temperature sensing signal. The Laplace transform can comprise a Laplace transform of the distributed temperature sensing signal. The wavelet transform can comprise a wavelet transform of the distributed temperature sensing signal or of the derivative of the distributed temperature sensing signal with respect to length (e.g., depth). The derivative of the distributed temperature sensing signal with respect to length (e.g., depth) can comprise the derivative of the flowing temperature with respect to depth. The heat loss parameter can comprise one or more of the geothermal temperature, a deviation, dimensions of the tubulars that are in the well, well head pressure, individual separator rates, downhole pressure, gas/liquid ratio, or the like. The autocorrelation can comprise a cross-correlation of the distributed temperature sensing signal with itself.

The frequency domain features can be determined using the acoustic monitoring system to obtain acoustic measurements at the location of the piece of equipment (e.g., along the length being monitored, such as along the length of the fiber optic cable 162 or a point sensor at the location of the at least one piece of equipment). In some embodiments, a DAS system can be used to receive distributed acoustic measurement signals from a sensor disposed along the length (e.g., the length of the wellbore), such as an optical fiber 162. The resulting signals from the acoustic monitoring system can be used to determine one or more frequency domain features as described herein. In some embodiments, a baseline or background acoustic profile can be used to determine the frequency domain features, and the baseline acoustic profile can be obtained prior to obtaining the acoustic measurements.

The one or more frequency domain features used to identify the event and/or as part of the correlation of the event with the one or more sensor outputs can include any frequency domain features noted hereinabove as well as combinations and transformations thereof. For example, In some embodiments, the one or more frequency domain features comprise a spectral centroid, a spectral spread, a spectral roll-off, a spectral skewness, an RMS band energy, a total RMS energy, a spectral flatness, a spectral slope, a spectral kurtosis, a spectral flux, a spectral autocorrelation function, combinations and/or transformations thereof, or any normalized variant thereof. In some embodiments, the one or more frequency domain features comprise a normalized variant of the spectral spread (NVSS) and/or a normalized variant of the spectral centroid (NVSC).

Once the suitable temperature, strain, and/or acoustic features are obtained, the features can be correlated with one or more event identification models to identify the event (e.g., identify the presence of the event, the location of the event, and/or the specific identify of the event itself). In some embodiments, the event models can accept a plurality of temperature, strain, and/or temperature features as inputs. In general, the features can be representative of a feature at a particular location (e.g., at the first location), for example, along the length of the distributed sensor. The one or more event models can comprise one or more models configured to accept the temperature, strain, and/or frequency domain feature(s) as input(s) and provide identification of the event at the first location. The output of the integrity event predictor model(s) can be in the form of a binary yes/no result (e.g., the event is or is not present), and/or a likelihood of an event (e.g., a percentage likelihood of the event occurring, etc.). Other outputs providing an identification of the event are also possible. In some embodiments, event identification models can comprise a machine learning model using supervised or unsupervised learning algorithms such as a multivariate model, neural network, or the like.

In some embodiments, the event identification model(s) can comprise a multivariate model. A multivariate model allows for the use of a plurality of variables in a model to determine or predict an outcome. A multivariate model can be developed using known data on events along with features for those events to develop a relationship between the features and the prediction of the event at the locations within the available data. One or more multivariate models can be developed using data, where each multivariate model uses a plurality of features as inputs to determine the likelihood of an event occurring at the particular location along the length (e.g., at the location of the at least one piece of equipment).

As noted above, in some embodiments, the event model(s) can comprise one or more multivariate models that use one or more features (e.g., temperature features, frequency domain features, strain features, other features derived from other types of sensors, or combinations thereof, etc.). The multivariate model can use multivariate equations, and the multivariate model equations can use the features or combinations or transformations thereof to determine when an event is identified or present. The multivariate model can define a threshold, decision point, and/or decision boundary having any type of shapes such as a point, line, surface, or envelope between the presence and absence of the event. In some embodiments, the multivariate model can be in the form of a polynomial, though other representations are also possible. The model can include coefficients that can be calibrated based on known event data. While there can be variability or uncertainty in the resulting values used in the model, the uncertainty can be taken into account in the output of the model. Once calibrated or tuned, the model can then be used with the corresponding features to provide an output that is indicative of the likelihood of an event.

The multivariate model is not limited to two dimensions (e.g., two features or two variables representing transformed values from two or more features), and rather can have any number of variables or dimensions in defining the threshold between the predicted presence or absence of the event. When used, the values can be used in the multivariate model, and the calculated value can be compared to the model values. The presence of the event can be indicated when the calculated value is on one side of the threshold and the absence of the event can be indicated when the calculated value is on the other side of the threshold. In some embodiments, the output of the multivariate model can be based on a value from the model relative to a normal distribution for the model. Thus, the model can represent a distribution or envelope and the resulting features can be used to define where the output of the model lies along the distribution at the location along the length being monitored (e.g., at the first location). Thus, each multivariate model can, in some embodiments, represent a specific determination between the presence or absence of an event at the specific location (e.g., along the length being monitored). Different multivariate models, and therefore thresholds, can be used for different events, and each multivariate model can rely on different features or combinations or transformations of features. Since the multivariate models define thresholds for the identification and/or prediction of events, the multivariate models and the event models using such multivariate models can be considered to be based on event signatures for each type of event.

In some embodiments, the event identification model(s) can also comprise other types of models, including other machine learning models. In some embodiments, a machine learning approach comprises a logistic regression model. In some such embodiments, one or more features can be used to determine if an event is identified at one or more locations of interest. The machine learning approach can rely on a training data set that can be obtained from actual data from known events (e.g., from the one or more sensor outputs in combination with the event identification and correlation as described herein in any of the aspects or embodiments). The one or more features in the training data set can then be used to train the one or more event models using machine learning, including any supervised or unsupervised learning approach. For example, the one or more event models can include or consist of a neural network, a Bayesian network, a decision tree, a logistical regression model, a normalized logistical regression model, or the like. In some embodiments, the event models can comprise a model developed using unsupervised learning techniques such a k-means clustering and the like.

In some embodiments, the event models can be developed and trained using a logistic regression model. As an example for training of a model used to determine the likelihood of an event, the training of the model can begin with providing the one or more temperature, strain, and/or acoustic features to the logistic regression model corresponding to one or more reference data sets in which event(s) are present. Additional reference data sets can be provided in which event(s) are not present. The one or more features can be provided to the logistic regression model, and a multivariate model can be determined using the one or more features as inputs. The first multivariate model can define a relationship between a presence and an absence of the events, and thus an identification of the likelihood of the event(s).

Regardless of the exact nature of the models, the event identification can then be used with any of the methods and systems described herein. Further, the same or similar models can be used with the one or more sensor outputs, or features derived therefrom, in order to develop and use new models for identifying the event(s). This can provide a system that allows for multiple sensor types to be used to identify events occurring within a system, identify the causes of certain events, and/or provide for improved control of the system.

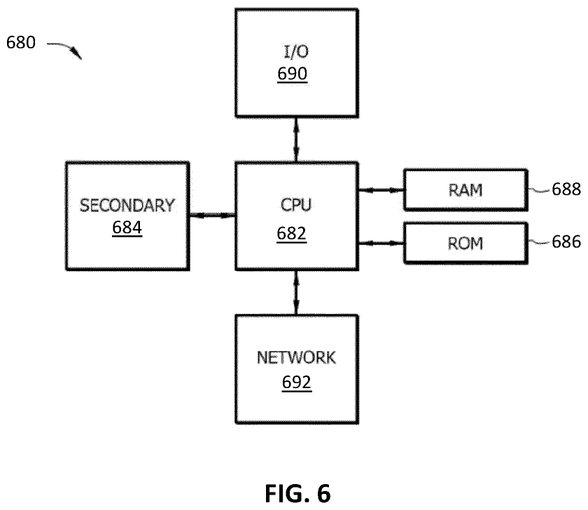

Any of the systems and methods disclosed herein can be carried out on a computer or other device comprising a processor (e.g., a desktop computer, a laptop computer, a tablet, a server, a smartphone, or some combination thereof), such as the acquisition device 160 of FIG. 3. FIG. 6 illustrates a computer system 680 suitable for implementing one or more embodiments disclosed herein such as the acquisition device or any portion thereof. The computer system 680 includes a processor 682 (which may be referred to as a central processor unit or CPU) that is in communication with memory devices including secondary storage 684, read only memory (ROM) 686, random access memory (RAM) 688, input/output (I/O) devices 690, and network connectivity devices 692. The processor 682 may be implemented as one or more CPU chips.

It is understood that by programming and/or loading executable instructions onto the computer system 680, at least one of the CPU 682, the RAM 688, and the ROM 686 are changed, transforming the computer system 680 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 680 is turned on or booted, the CPU 682 may execute a computer program or application. For example, the CPU 682 may execute software or firmware stored in the ROM 686 or stored in the RAM 688. In some cases, on boot and/or when the application is initiated, the CPU 682 may copy the application or portions of the application from the secondary storage 684 to the RAM 688 or to memory space within the CPU 682 itself, and the CPU 682 may then execute instructions of which the application is comprised. In some cases, the CPU 682 may copy the application or portions of the application from memory accessed via the network connectivity devices 692 or via the I/O devices 690 to the RAM 688 or to memory space within the CPU 682, and the CPU 682 may then execute instructions of which the application is comprised. During execution, an application may load instructions into the CPU 682, for example load some of the instructions of the application into a cache of the CPU 682. In some contexts, an application that is executed may be said to configure the CPU 682 to do something, e.g., to configure the CPU 682 to perform the function or functions promoted by the subject application. When the CPU 682 is configured in this way by the application, the CPU 682 becomes a specific purpose computer or a specific purpose machine.

The secondary storage 684 is typically comprised of one or more disk drives or tape drives and is used for non-volatile storage of data and as an over-flow data storage device if RAM 688 is not large enough to hold all working data. Secondary storage 684 may be used to store programs which are loaded into RAM 688 when such programs are selected for execution. The ROM 686 is used to store instructions and perhaps data which are read during program execution. ROM 686 is a non-volatile memory device which typically has a small memory capacity relative to the larger memory capacity of secondary storage 684. The RAM 688 is used to store volatile data and perhaps to store instructions. Access to both ROM 686 and RAM 688 is typically faster than to secondary storage 684. The secondary storage 684, the RAM 688, and/or the ROM 686 may be referred to in some contexts as computer readable storage media and/or non-transitory computer readable media.

I/O devices 690 may include printers, video monitors, electronic displays (e.g., liquid crystal displays (LCDs), plasma displays, organic light emitting diode displays (OLED), touch sensitive displays, etc.), keyboards, keypads, switches, dials, mice, track balls, voice recognizers, card readers, paper tape readers, or other well-known input devices.

The network connectivity devices 692 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 692 may enable the processor 682 to communicate with the Internet or one or more intranets. With such a network connection, it is contemplated that the processor 682 might receive information from the network, or might output information to the network (e.g., to an event database) in the course of performing the above-described method steps. Such information, which is often represented as a sequence of instructions to be executed using processor 682, may be received from and outputted to the network, for example, in the form of a computer data signal embodied in a carrier wave.

Such information, which may include data or instructions to be executed using processor 682 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 682 executes instructions, codes, computer programs, scripts which it accesses from hard disk, floppy disk, optical disk (these various disk based systems may all be considered secondary storage 684), flash drive, ROM 686, RAM 688, or the network connectivity devices 692. While only one processor 682 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 684, for example, hard drives, floppy disks, optical disks, and/or other device, the ROM 686, and/or the RAM 688 may be referred to in some contexts as non-transitory instructions and/or non-transitory information.

In an embodiment, the computer system 680 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 680 to provide the functionality of a number of servers that is not directly bound to the number of computers in the computer system 680. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 680, at least portions of the contents of the computer program product to the secondary storage 684, to the ROM 686, to the RAM 688, and/or to other non-volatile memory and volatile memory of the computer system 680. The processor 682 may process the executable instructions and/or data structures in part by directly accessing the computer program product, for example by reading from a CD-ROM disk inserted into a disk drive peripheral of the computer system 680. Alternatively, the processor 682 may process the executable instructions and/or data structures by remotely accessing the computer program product, for example by downloading the executable instructions and/or data structures from a remote server through the network connectivity devices 692. The computer program product may comprise instructions that promote the loading and/or copying of data, data structures, files, and/or executable instructions to the secondary storage 684, to the ROM 686, to the RAM 688, and/or to other non-volatile memory and volatile memory of the computer system 680.

In some contexts, the secondary storage 684, the ROM 686, and the RAM 688 may be referred to as a non-transitory computer readable medium or a computer readable storage media. A dynamic RAM embodiment of the RAM 688, likewise, may be referred to as a non-transitory computer readable medium in that while the dynamic RAM receives electrical power and is operated in accordance with its design, for example during a period of time during which the computer system 680 is turned on and operational, the dynamic RAM stores information that is written to it. Similarly, the processor 682 may comprise an internal RAM, an internal ROM, a cache memory, and/or other internal non-transitory storage blocks, sections, or components that may be referred to in some contexts as non-transitory computer readable media or computer readable storage media.

Having described various systems and methods, certain aspects can include, but are not limited to:

In a first aspect, a method of identifying parameters associated with an event comprises identifying an event at a first location; correlating the event with one or more sensor outputs, wherein the one or more sensor outputs are obtained from a location other than the first location; identifying at least one sensor output of the one or more sensor outputs correlated with the event at the first location; and displaying the at least one sensor output along with an indication of the event.

A second aspect can include the method of the first aspect, further comprising: controlling at least one piece of equipment associated with the at least one sensor output, wherein the at least one piece of equipment is part of the system; and changing the event based on controlling the at least one piece of equipment.

A third aspect can include the method of the first or second aspect, wherein identifying the event at the first location comprises: obtaining an acoustic signal at the first location; determining a plurality of frequency domain features from the acoustic signal; using at least one frequency domain feature of the plurality of frequency domain features as an input to an event model; and determining the presence and identity of the event using an output of the event model.

A fourth aspect can include the method of the first or second aspect, wherein identifying the event at the first location comprises: obtaining a thermal signal at the first location; determining a plurality of temperature features from the thermal signal; using at least one temperature feature of the plurality of temperature features as an input to an event model; and determining the presence and identity of the event using an output of the event model.

A fifth aspect can include the method of any one of the first to fourth aspects, wherein the one or more sensor outputs comprise at least one of: a temperature sensor, a flow meter, a pressure sensor, a choke position, a valve position, a pump setting, or a rain sensor.

A sixth aspect can include the method of any one of the first to fifth aspects, wherein correlating the event with the one or more sensor outputs comprises: correlating the event with the one or more sensor outputs through time.

A seventh aspect can include the method of the sixth aspect, wherein correlating the event with the one or more sensor outputs through time comprises identifying a time lag between the event and the one or more sensor outputs.

An eighth aspect can include the method of any one of the first to seventh aspects, determining a source location of the at least one event based on the correlating.

A ninth aspect can include the method of any one of the first to eighth aspects, wherein the one or more sensor outputs are different than any sensor outputs used to identify the event.

A tenth aspect can include the method of any one of the first to ninth aspects, wherein the event comprises sand ingress, fluid inflow, fluid flow along the wellbore, a leak event, an overburden event, a fracture, or any combination thereof.

An eleventh aspect can include the method of any one of the first to tenth aspects, wherein the one or more sensor outputs are obtained from a distributed sensor.

A twelfth aspect can include the method of the eleventh aspect, wherein identifying the at least one sensor output of the one or more sensor outputs comprises: identifying the at least one sensor output associated with a plurality of locations along the distributed sensor, and identifying an occurrence of the event at the plurality of locations along the distributed sensor.

A thirteenth aspect can include the method of any one of the first to tenth aspects, further comprising: identifying the presence of a second event based on the at least one sensor output and the identification of the event, wherein the second event is associated with the event.

In a fourteenth aspect, a system of identifying parameters associated with an event comprises a processor; a memory, wherein the memory stores a processing application, wherein the processing application, when executed on the processor, configures the processor to: receive a signal originating at a first location; identify an event at the first location using the signal; correlate the event with one or more sensor outputs, wherein the one or more sensor outputs originate from a location other than the first location; identify at least one sensor output of the one or more sensor outputs correlated with the event at the first location; and display the at least one sensor output along with an indication of the event.

A fifteenth aspect can include the system of the fourteenth aspect, wherein the processor is further configured to: generate a control signal for at least one piece of equipment associated with the at least one sensor output, wherein the at least one piece of equipment is part of the system; and send the control signal to the at least one piece of equipment, wherein the event is changed based on the control signal being sent to the at least one piece of equipment.

A sixteenth aspect can include the system of the fourteenth or fifteenth aspect, wherein the processor is further configured to: obtain an acoustic signal at the first location; determine a plurality of frequency domain features from the acoustic signal; use at least one frequency domain feature of the plurality of frequency domain features as an input to an event model; and determine the presence and identity of the event using an output of the event model.

A seventeenth aspect can include the system of the fourteenth or fifteenth aspect, wherein the processor is further configured to: obtain a thermal signal at the first location; determine a plurality of temperature features from the thermal signal; use at least one temperature feature of the plurality of temperature features as an input to an event model; and determine the presence and identity of the event using an output of the event model.

An eighteenth aspect can include the system of any one of the fourteenth to seventeenth aspects, wherein the one or more sensor outputs comprise at least one of: a temperature sensor, a flow meter, a pressure sensor, a choke position, a valve position, or a pump setting.

A nineteenth aspect can include the system of any one of the fourteenth to eighteenth aspects, wherein the processor is further configured to: correlate the event with the one or more sensor outputs through time.

A twentieth aspect can include the system of the nineteenth aspect, wherein the correlation of the event with the one or more sensor outputs through time comprises an identification of a time lag between the event and the one or more sensor outputs.

A twenty first aspect can include the system of any one of the fourteenth to twentieth aspects, wherein the processor is further configured to: determine a source location of the at least one event based on the correlating.

A twenty second aspect can include the system of any one of the fourteenth to twenty first aspects, wherein the one or more sensor outputs are different than any sensor outputs used to identify the event.

A twenty third aspect can include the system of any one of the fourteenth to twenty second aspects, wherein the event comprises sand ingress, fluid inflow, fluid flow along the wellbore, a leak event, an overburden event, a fracture, or any combination thereof.

A twenty fourth aspect can include the system of any one of the fourteenth to twenty third aspects, wherein the one or more sensor outputs are obtained from a distributed sensor.

A twenty fifth aspect can include the system of the twenty fourth aspect, wherein the processor is further configured to: identify the at least one sensor output associated with a plurality of locations along the distributed sensor, and identify an occurrence of the event at the plurality of locations along the distributed sensor.

A twenty sixth aspect can include the system of any one of the fourteenth to twenty fifth aspects, wherein the processor is further configured to: identifying the presence of a second event based on the at least one sensor output and the identification of the event, wherein the second event is associated with the event.

In a twenty seventh aspect, a method comprises: identify a first occurrence of an event at a first depth within a wellbore; correlating the event with one or more sensor outputs, wherein the one or more sensor outputs are obtained from a location other than the first depth; identifying at least one sensor output of the one or more sensor outputs correlated with the event at the first depth; labeling training data using the at least one sensor output and the identification of the event from the first occurrence of the event; training a model using the training data; identifying a second occurrence of the event using data for the at least one sensor output at a second time.

A twenty eighth aspect can include the method of the twenty seventh aspect, wherein the model comprises a machine learning model.

A twenty ninth aspect can include the method of the twenty seventh or twenty eighth aspect, wherein identifying the first occurrence of the event comprises using one or more features associated with the event in a model.

A thirtieth aspect can include the method of the twenty ninth aspect, wherein the one or more features are time domain features, frequency domain features, or a combination thereof.

A thirty first aspect can include the method of the twenty ninth or thirtieth aspect, wherein the one or more sensor outputs comprise outputs of sensors located outside of the wellbore.

A thirty second aspect can include the method of any one of the twenty ninth to thirty first aspects, wherein the one or more sensor outputs occur prior to one or more features used to identify the first occurrence of the event, and wherein identifying the second occurrence of the event comprises predicting the second occurrence of the event prior to the second occurrence of the second event.

In a thirty third aspect, a method of identifying fluid inflow within a sewer system comprises: identifying a fluid flow at a first location; correlating the fluid flow with one or more sensor outputs, wherein the one or more sensor outputs are obtained from a plurality of locations along a sewer system; identifying at least one sensor output of the one or more sensor outputs correlated with the fluid flow at the first location; and identifying a leak location in the sewer based on identifying the fluid flow and the at least one sensor output.

A thirty fourth aspect can include the method of the thirty third aspect, wherein the fluid flow comprises rainfall.

A thirty fifth aspect can include the method of the thirty third or thirty fourth aspect, further comprising: identifying a plurality of leak locations into the sewer based on identifying the fluid flow and the at least one sensor output.

A thirty sixth aspect can include the method of any one of the thirty third or thirty fifth aspects, further comprising: identifying an increased flowrate through the sewer based on the at least one sensor output.

A thirty seventh aspect can include the method of any one of the thirty third or thirty sixth aspects, wherein the at least one sensor output comprises a plurality of types of sensor outputs.

The drawing figures are not necessarily to scale. Certain features and components herein may be shown exaggerated in scale or in somewhat schematic form and some details of conventional elements may not be shown in interest of clarity and conciseness.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to . . . ”. Reference to up or down will be made for purposes of description with “up,” “upper,” “upward,” “upstream,” or “above” meaning toward the surface of the wellbore and with “down,” “lower,” “downward,” “downstream,” or “below” meaning toward the terminal end of the well, regardless of the wellbore orientation. Reference to inner or outer will be made for purposes of description with “in,” “inner,” or “inward” meaning towards the central longitudinal axis of the wellbore and/or wellbore tubular, and “out,” “outer,” or “outward” meaning towards the wellbore wall. As used herein, the term “longitudinal” or “longitudinally” refers to an axis substantially aligned with the central axis of the wellbore tubular, and “radial” or “radially” refer to a direction perpendicular to the longitudinal axis. The various characteristics mentioned above, as well as other features and characteristics described in more detail below, will be readily apparent to those skilled in the art with the aid of this disclosure upon reading the following detailed description of the embodiments, and by referring to the accompanying drawings.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A method of identifying parameters associated with an event, the method comprising:
identifying an event at a first location;
correlating the event with one or more sensor outputs, wherein the one or more sensor outputs are obtained from a location other than the first location;
identifying at least one sensor output of the one or more sensor outputs correlated with the event at the first location; and
displaying the at least one sensor output along with an indication of the event.

2. The method of claim 1, further comprising:
controlling at least one piece of equipment associated with the at least one sensor output, wherein the at least one piece of equipment is part of the system; and
changing the event based on controlling the at least one piece of equipment.

3. The method of claim 1, wherein identifying the event at the first location comprises:
obtaining an acoustic signal at the first location;
determining a plurality of frequency domain features from the acoustic signal;
using at least one frequency domain feature of the plurality of frequency domain features as an input to an event model; and
determining the presence and identity of the event using an output of the event model.

4. The method of claim 1, wherein identifying the event at the first location comprises:
obtaining a thermal signal at the first location;
determining a plurality of temperature features from the thermal signal;
using at least one temperature feature of the plurality of temperature features as an input to an event model; and
determining the presence and identity of the event using an output of the event model.

5. The method of claim 1, wherein the one or more sensor outputs comprise at least one of: a temperature sensor, a flow meter, a pressure sensor, a choke position, a valve position, a pump setting, or a rain sensor.

6. The method of claim 1, wherein correlating the event with the one or more sensor outputs comprises:
correlating the event with the one or more sensor outputs through time, wherein correlating the event with the one or more sensor outputs through time comprises identifying a time lag between the event and the one or more sensor outputs.

7. (canceled)

8. The method of claim 1, determining a source location of the at least one event based on the correlating.

9. The method of claim 1, wherein the one or more sensor outputs are different than any sensor outputs used to identify the event.

10. The method of claim 1, wherein the event comprises sand ingress, fluid inflow, fluid flow along the wellbore, a leak event, an overburden event, a fracture, or any combination thereof.

11. The method of claim 1, wherein the one or more sensor outputs are obtained from a distributed sensor, wherein identifying the at least one sensor output of the one or more sensor outputs comprises:
identifying the at least one sensor output associated with a plurality of locations along the distributed sensor, and
identifying an occurrence of the event at the plurality of locations along the distributed sensor.

12. (canceled)

13. (canceled)

14. A system of identifying parameters associated with an event, the system comprising:
a processor;
a memory, wherein the memory stores a processing application, wherein the processing application, when executed on the processor, configures the processor to:
receive a signal originating at a first location;
identify an event at the first location using the signal;
correlate the event with one or more sensor outputs, wherein the one or more sensor outputs originate from a location other than the first location;
identify at least one sensor output of the one or more sensor outputs correlated with the event at the first location; and
display the at least one sensor output along with an indication of the event.

15. The system of claim 14, wherein the processor is further configured to:
generate a control signal for at least one piece of equipment associated with the at least one sensor output, wherein the at least one piece of equipment is part of the system; and
send the control signal to the at least one piece of equipment, wherein the event is changed based on the control signal being sent to the at least one piece of equipment.

16. The system of claim 14, wherein the processor is further configured to:
obtain an acoustic signal at the first location;
determine a plurality of frequency domain features from the acoustic signal;
use at least one frequency domain feature of the plurality of frequency domain features as an input to an event model; and
determine the presence and identity of the event using an output of the event model.

17. The system of claim 14, wherein the processor is further configured to:
obtain a thermal signal at the first location;
determine a plurality of temperature features from the thermal signal;
use at least one temperature feature of the plurality of temperature features as an input to an event model; and
determine the presence and identity of the event using an output of the event model.

18. The system of claim 14, wherein the one or more sensor outputs comprise at least one of: a temperature sensor, a flow meter, a pressure sensor, a choke position, a valve position, or a pump setting.

19. The system of claim 14, wherein the processor is further configured to:
correlate the event with the one or more sensor outputs through time, wherein the correlation of the event with the one or more sensor outputs through time comprises an identification of a time lag between the event and the one or more sensor outputs.

20. (canceled)

21. The system of claim 14, wherein the processor is further configured to:
determine a source location of the at least one event based on the correlating.

22. The system of claim 14, wherein the one or more sensor outputs are different than any sensor outputs used to identify the event.

23. The system of claim 14, wherein the event comprises sand ingress, fluid inflow, fluid flow along the wellbore, a leak event, an overburden event, a fracture, or any combination thereof.

24. The system of claim 14, wherein the one or more sensor outputs are obtained from a distributed sensor, wherein the processor is further configured to:
identify the at least one sensor output associated with a plurality of locations along the distributed sensor, and,
identify the at least one sensor output associated with a plurality of locations along the distributed sensor, and
identify an occurrence of the event at the plurality of locations along the distributed sensor.

25. (canceled)

26. (canceled)

27. A method comprising:
identify a first occurrence of an event at a first depth within a wellbore;
correlating the event with one or more sensor outputs, wherein the one or more sensor outputs are obtained from a location other than the first depth;
identifying at least one sensor output of the one or more sensor outputs correlated with the event at the first depth;
labeling training data using the at least one sensor output and the identification of the event from the first occurrence of the event;
training a model using the training data;
identifying a second occurrence of the event using data for the at least one sensor output at a second time.

28. The method of claim 27, wherein the model comprises a machine learning model and wherein identifying the first occurrence of the event comprises using one or more features associated with the event in the machine learning model.

29. (canceled)

30. The method of claim 28, wherein the one or more features are time domain features, frequency domain features, or a combination thereof.

31. The method of claim 28, wherein the one or more sensor outputs comprise outputs of sensors located outside of the wellbore.

32. The method of claim 27, wherein the one or more sensor outputs occur prior to one or more features used to identify the first occurrence of the event, and wherein identifying the second occurrence of the event comprises predicting the second occurrence of the event prior to the second occurrence of the second event.

33.-37. (canceled)
